(19) United States
(12) Patent Application Publication
(10) Pub. No.: US 2025/0260466 A1
(43) Pub. Date: Aug. 14, 2025

(54) SIGNALING ENHANCEMENT FOR BEAM CHANGE PREDICTIONS VIA MODELING

(71) Applicant: QUALCOMM INCORPORATED, San Diego, CA (US)

(72) Inventors: Qiaoyu Li, Beijing (CN); Arumugam Chendamarai Kannan, San Diego, CA (US); Mahmoud Taherzadeh Boroujeni, San Diego, CA (US); Tao Luo, San Diego, CA (US)

(21) Appl. No.: 18/704,850

(22) PCT Filed: Apr. 14, 2022
(86) PCT No.: PCT/CN2022/086787

§ 371 Date: Apr. 25, 2024

(30) Foreign Application Priority Data
Dec. 15, 2021 (WO) PCT/CN2021/138235

(51) Int. Cl. H04B 7/06; H04L 41/16; H04W 24/10

(52) U.S. Cl. CPC H04B 7/06952; H04B 7/0626; H04L 41/16; H04W 24/10

(57) ABSTRACT

Methods, systems, and devices for wireless communications are described. A user equipment (UE) may receive a reference signal from a network node. The reference signal may be associated with a beam, of a set of beams. Each beam of the set of beams may be associated with a respective beam index. The UE may determine a probability associated with an adjustment of the beam. The probability may indicate whether the beam will change over a duration from a first beam associated with a first beam index to a second beam associated with a second beam index based on the reference signal. The UE may transmit an indication of the probability associated with the adjustment of the beam to the network node.

### CROSS REFERENCES

The present Application is a 371 national stage filing of International PCT Application No. PCT/CN2022/086787 by Li et al. entitled “SIGNALING ENHANCEMENT FOR BEAM CHANGE PREDICTIONS VIA MODELING,” filed Apr. 14, 2022; and claims priority to International Patent Application No. PCT/CN2021/138235 by Li et al. entitled “SIGNALING ENHANCEMENT FOR BEAM CHANGE PREDICTIONS VIA MODELING,” filed Dec. 15, 2021, each of which is assigned to the assignee hereof, and each of which is expressly incorporated by reference in its entirety herein.

### TECHNICAL FIELD

The following relates to wireless communications, including signaling enhancement for beam change predictions via modeling.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, or one or more access network entities, each simultaneously supporting communication for multiple communication devices, which may be otherwise known as user equipment (UE).

Some wireless communications systems may support beamforming operations for directional communications. Beamforming involves a signal processing technique in which a transmitting communication device, or a receiving communication device, or both, select, shape, or steer an antenna beam (for example, a directional beam) along a spatial path between the two communication devices (for example, between a base station and a UE). Some communication devices (for example, base stations) may use beamforming to simultaneously support wireless communications (for example, downlink communications) in multiple directions. For example, a base station may support simultaneous downlink communications for multiple UEs in different locations or for a single UE moving from a first location to a second location. In some examples, a directional beam that may be suitable for transmitting downlink communications to a UE at the first location may not be suitable for transmitting downlink communications to the UE (or another UE, or both the UE and another UE) at the second location. In such examples, the base station may select a first beam to transmit downlink communications to the UE at the first location, and select a second beam to transmit downlink communications to the UE (or another UE, or both the UE and another UE) at the second location. In some cases, however, the UE may not be aware that the change will occur and, as a result, may lose a connection with the base station. Or, alternatively, the UE may predict whether a beam change may occur at a future time, but in some cases conditions or parameters (for example, a beam index) may not change over a duration, and the UE may incorrectly predict that a beam change will occur and unnecessarily alter the behavior of the UE or unnecessarily expend power determining that no change will occur. In some cases, unnecessary changes in the behavior of the UE may result in increased power consumption and reduced link performance, and some methods of the UE trying to predict the beam change may be complex, prohibitive, and rigid.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication at a user equipment (UE). The method includes receiving, from a network node, a reference signal associated with a beam of a set of beams used for wireless communications at the UE, each beam of the set of beams being associated with a respective beam index, determining a probability associated with an adjustment of the beam, the probability indicating whether the beam will change over a duration from a first beam associated with a first beam index to a second beam associated with a second beam index based on the reference signal, and transmitting, to the network node, an indication of the probability associated with the adjustment of the beam.

Another innovative aspect of the subject matter described in this disclosure can be implemented in an apparatus for wireless communication at a UE. The apparatus includes a processor, memory coupled with the processor, and instructions stored in the memory. The instructions may be executable by the processor to cause the apparatus to receive, from a network node, a reference signal associated with a beam of a set of beams used for wireless communications at the UE, each beam of the set of beams being associated with a respective beam index, determine a probability associated with an adjustment of the beam, the probability indicating whether the beam will change over a duration from a first beam associated with a first beam index to a second beam associated with a second beam index based on the reference signal, and transmit, to the network node, an indication of the probability associated with the adjustment of the beam.

Another innovative aspect of the subject matter described in this disclosure can be implemented in an apparatus for wireless communication at a UE. The apparatus includes means for receiving, from a network node, a reference signal associated with a beam of a set of beams used for wireless communications at the UE, each beam of the set of beams being associated with a respective beam index, means for determining a probability associated with an adjustment of the beam, the probability indicating whether the beam will change over a duration from a first beam associated with a first beam index to a second beam associated with a second beam index based on the reference signal, and means for transmitting, to the network node, an indication of the probability associated with the adjustment of the beam.

Another innovative aspect of the subject matter described in this disclosure can be implemented in a non-transitory computer-readable medium storing code for wireless communication at a UE. The code includes instructions executable by a processor to receive, from a network node, a reference signal associated with a beam of a set of beams used for wireless communications at the UE, each beam of the set of beams being associated with a respective beam index, determine a probability associated with an adjustment of the beam, the probability indicating whether the beam will change over a duration from a first beam associated with a first beam index to a second beam associated with a second beam index based on the reference signal, and transmit, to the network node, an indication of the probability associated with the adjustment of the beam.

In some examples of the method, apparatuses, and non-transitory computer-readable medium described herein, transmitting an indication of the probability may include operations, features, means, or instructions for transmitting, to the network node, a status indication associated with whether the adjustment of the beam will occur, where transmitting the status indication may be based on the probability.

Some examples of the method, apparatuses, and non-transitory computer-readable medium described herein may further include operations, features, means, or instructions for receiving, from the network node, an indication of a threshold and determining whether the probability satisfies the threshold, where transmitting the status indication may be based on the probability satisfying the threshold.

Another innovative aspect of the subject matter described in this disclosure can be implemented in a method for wireless communication at a user equipment (UE). The method includes receiving, from a base station, an indication of a hidden Markov model (HMM) configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams, receiving, from the base station, a reference signal associated with a beam of the set of beams, performing a measurement on the beam over a beam measurement cycle based on the indication of the HMM configuration, and transmitting, to the base station, a status indication associated with whether an adjustment of the beam will occur, the status indication based on the HMM configuration and performing the measurement on the beam.

Another innovative aspect of the subject matter described in this disclosure can be implemented in an apparatus for wireless communication at a UE. The apparatus includes a processor, memory coupled with the processor, and instructions stored in the memory. The instructions may be executable by the processor to cause the apparatus to receive, from a base station, an indication of an HMM configuration, the HMM including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams, receive, from the base station, a reference signal associated with a beam of the set of beams, perform a measurement on the beam over a beam measurement cycle based on the indication of the HMM configuration, and transmit, to the base station, a status indication associated with whether an adjustment of the beam will occur, the status indication based on the HMM configuration and performing the measurement on the beam.

Another innovative aspect of the subject matter described in this disclosure can be implemented in an apparatus for wireless communication at a UE. The apparatus includes means for receiving, from a base station, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams, means for receiving, from the base station, a reference signal associated with a beam of the set of beams, means for performing a measurement on the beam over a beam measurement cycle based on the indication of the HMM configuration, and means for transmitting, to the base station, a status indication associated with whether an adjustment of the beam will occur, the status indication based on the HMM configuration and performing the measurement on the beam.

Another innovative aspect of the subject matter described in this disclosure can be implemented in a non-transitory computer-readable medium storing code for wireless communication at a UE. The code includes instructions executable by a processor to receive, from a base station, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams, receive, from the base station, a reference signal associated with a beam of the set of beams, perform a measurement on the beam over a beam measurement cycle based on the indication of the HMM configuration, and transmit, to the base station, a status indication associated with whether an adjustment of the beam will occur, the status indication based on the HMM configuration and performing the measurement on the beam.

In some examples of the method, apparatuses, and non-transitory computer-readable medium described herein, the set of transition probabilities and the set of emission probabilities of the HMM configuration may be associated with whether a beam metric changed from a second beam measurement cycle to the beam measurement cycle, the beam metric based on performing the measurement on the beam.

Another innovative aspect of the subject matter described in this disclosure can be implemented in a method for wireless communication at a base station. The method includes transmitting, to a UE, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams, transmitting, to the UE, a reference signal associated with a beam of the set of beams, and receiving, from the UE, a status indication associated with whether an adjustment of the beam will occur, the status indication based on the HMM configuration and the reference signal.

Another innovative aspect of the subject matter described in this disclosure can be implemented in an apparatus for wireless communication at a base station. The apparatus includes a processor, memory coupled with the processor, and instructions stored in the memory. The instructions may be executable by the processor to cause the apparatus to transmit, to a UE, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams, transmit, to the UE, a reference signal associated with a beam of the set of beams, and receive, from the UE, a status indication associated with whether an adjustment of the beam will occur, the status indication based on the HMM configuration and the reference signal.

Another innovative aspect of the subject matter described in this disclosure can be implemented in an apparatus for wireless communication at a base station. The apparatus includes means for transmitting, to a UE, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams, means for transmitting, to the UE, a reference signal associated with a beam of the set of beams, and means for receiving, from the UE, a status indication associated with whether an adjustment of the beam will occur, the status indication based on the HMM configuration and the reference signal.

Another innovative aspect of the subject matter described in this disclosure can be implemented in a non-transitory computer-readable medium storing code for wireless communication at a base station. The code includes instructions executable by a processor to transmit, to a UE, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams, transmit, to the UE, a reference signal associated with a beam of the set of beams, and receive, from the UE, a status indication associated with whether an adjustment of the beam will occur, the status indication based on the HMM configuration and the reference signal.

In some examples of the method, apparatuses, and non-transitory computer-readable medium described herein, the set of transition probabilities and the set of emission probabilities of the HMM configuration may be associated with whether a beam metric changed from a second beam measurement cycle to a beam measurement cycle, the beam metric corresponding to a measurement of the beam.

### BRIEF DESCRIPTION OF THE DRAWINGS

FIGS. 1 and 2 each illustrate an example of a wireless communications system that supports signaling enhancement for beam change predictions via modeling in accordance with one or more aspects of the present disclosure.

FIG. 3 illustrates an example of a hidden Markov model (HMM) that supports signaling enhancement for beam change predictions via modeling in accordance with one or more aspects of the present disclosure.

FIGS. 4, 5A, and 5B each illustrate an example of a beam change prediction procedure that supports signaling enhancement for beam change predictions via modeling in accordance with one or more aspects of the present disclosure.

FIGS. 6A and 6B each illustrate an example of a sequence that supports signaling enhancement for beam change predictions via modeling in accordance with one or more aspects of the present disclosure.

FIG. 7 illustrates an example of a process flow that supports signaling enhancement for beam change predictions via modeling in accordance with one or more aspects of the present disclosure.

FIGS. 8 and 9 show block diagrams of devices that support signaling enhancement for beam change predictions via modeling in accordance with one or more aspects of the present disclosure.

FIG. 10 shows a block diagram of a communications manager that supports signaling enhancement for beam change predictions via modeling in accordance with one or more aspects of the present disclosure.

FIG. 11 shows a diagram of a system including a device that supports signaling enhancement for beam change predictions via modeling in accordance with one or more aspects of the present disclosure.

FIGS. 12 and 13 show flowcharts illustrating methods that support signaling enhancement for beam change predictions via modeling in accordance with one or more aspects of the present disclosure.

FIGS. 14 and 15 show block diagrams of devices that support signaling enhancement for beam change predictions via modeling in accordance with aspects of the present disclosure.

FIG. 16 shows a block diagram of a communications manager that supports signaling enhancement for beam change predictions via modeling in accordance with aspects of the present disclosure.

FIG. 17 shows a diagram of a system including a device that supports signaling enhancement for beam change predictions via modeling in accordance with aspects of the present disclosure.

FIGS. 18 and 19 show block diagrams of devices that support signaling enhancement for beam change predictions via modeling in accordance with aspects of the present disclosure.

FIG. 20 shows a block diagram of a communications manager that supports signaling enhancement for beam change predictions via modeling in accordance with aspects of the present disclosure.

FIG. 21 shows a diagram of a system including a device that supports signaling enhancement for beam change predictions via modeling in accordance with aspects of the present disclosure.

FIGS. 22 through 25 show flowcharts illustrating methods that support signaling enhancement for beam change predictions via modeling in accordance with aspects of the present disclosure.

### DETAILED DESCRIPTION

A first communication device (for example, a base station) may use multiple beams (for example, directional beams) to support communication with a second communication device (for example, a user equipment (UE)) as the second communication device moves throughout a geographic coverage area supported by the first communication device. However, the second communication device may not be aware that a beam change will occur as the second communication device moves and, as a result, the second communication device may lose a connection with the first communication device (for example, a downlink connection may be lost). To reduce the likelihood of losing the connection, the second communication device may predict whether the beam change may occur based on signal measurements by the second communication device. In some cases, however, beam conditions or parameters may not change over a duration (for example, hundreds of milliseconds (ms)) and the second communication device may unnecessarily expend power performing the signal measurements. Additionally or alternatively, the second communication device may incorrectly predict the beam change will occur and unnecessarily alter the behavior of the second communication device. These unnecessary changes in the behavior of the second communication device may result in increased power consumption and reduce link performance, among other disadvantages.

Various aspects generally relate to techniques for signaling enhancement for beam change predictions, and more specifically, for beam change predictions based on probabilities determined at a second communication device. In some examples, the second communication device may predict a beam change using a machine learning model, such as a hidden Markov model (HMM), a long short-term memory (LSTM) neural network, a gated recurrent unit (GRU) neural network, a convolution neural network (CNN), a recurrent neural network (RNN), or a deep neural network (DNN), among other examples. For example, the second communication device (for example, a UE) may use a machine learning model to predict a state (for example, whether a beam change at a first communication device will occur at a future time or over a future duration) based on one or both of information (for example, included in a machine learning model such as an HMM configuration) and observations (for example, signal measurements) made by the second communication device. The information, may include probabilities associated with the likelihood of a transition between a number of states and probabilities associated with the likelihood that an observation will occur given a state. The second communication device may signal a beam change prediction (for example, whether the beam will change, a probability that the beam will change) to the first communication device (for example, a network node). For example, the second communication device may use the machine learning model (for example, a machine learning model determined at the second communication device or configured for the second communication device by the first communication device) to estimate a probability of the beam change occurring at the future time or over the future duration, and in some examples, the second communication device may compare the estimated probability to a threshold to determine whether the beam change will occur. The second communication device may transmit an indication of the estimated probability (or the beam change prediction) to the first communication device, such that the first communication device may account for or use the beam change prediction indication in signaling to the second communication device or for adjustments for the second communication device.

Particular aspects of the subject matter described herein may be implemented to realize one or more of the following potential advantages. The techniques employed by the described communication devices may enable a flexible tradeoff between power consumption and link performance by predicting whether a beam change will occur at a future time or over a future duration. The first communication device (for example, the base station) may provide (for example, indicate) a machine learning model, such as via a machine learning model configuration (for example an HMM configuration), to improve procedures for predicting beam changes by increasing the reliability of beam change predictions, such as at the second communication device (for example, the UE). In some implementations, using a machine learning model to predict the probability that the beam change will occur will reduce a miss detection error rate and a false alarm rate associated with beam change predictions and avoid unnecessary changes or operations. In some implementations, operations performed by the described communication devices via modeling, such as via the machine learning model, support improvements to power consumption, reliability for downlink communications, and spectral efficiency, among other benefits.

Aspects of the disclosure are initially described in the context of wireless communications systems. Aspects of the disclosure are also described in the context of an HMM, beam change prediction procedures, a result sequence, and a process flow. Aspects of the disclosure are further illustrated by and described with reference to apparatus diagrams, system diagrams, and flowcharts that relate to signaling enhancement for beam change predictions via modeling.

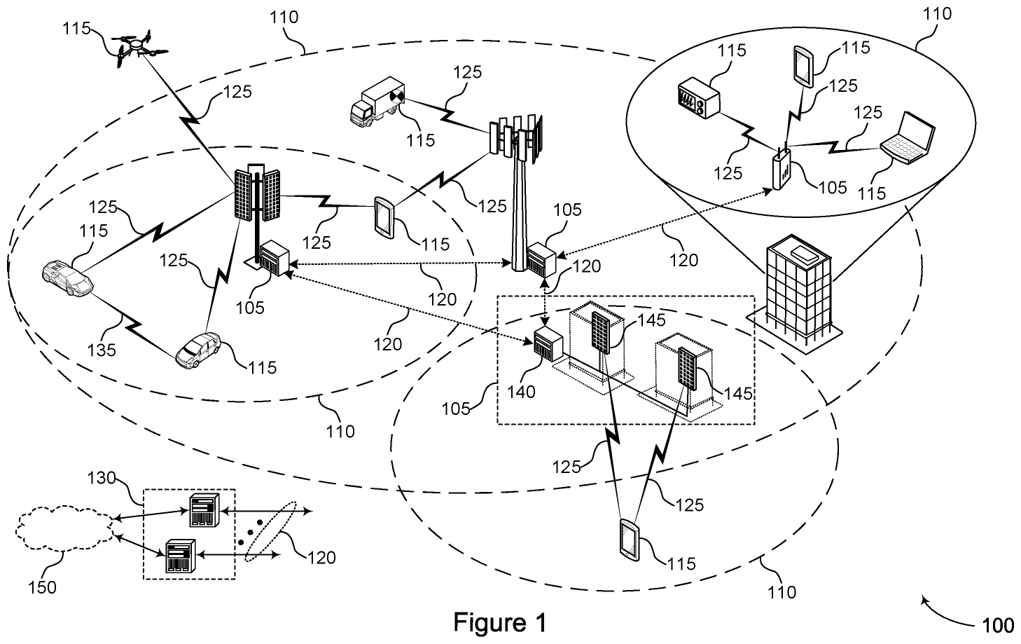

FIG. 1 illustrates an example of a wireless communications system 100 that supports signaling enhancement for beam change predictions via modeling in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (for example, core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (for example, via an S1, N2, N3, or other interface). The base stations 105 may communicate with one another over the backhaul links 120 (for example, via an X2, Xn, or other interface) either directly (for example, directly between base stations 105), or indirectly (for example, via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, in which the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (for example, a duration of one modulation symbol) and one subcarrier, in which the symbol period and subcarrier spacing are inversely related. The number of bits carried by each resource element may depend on the modulation scheme (for example, the order of the modulation scheme, the coding rate of the modulation scheme, or both). The more resource elements that a UE 115 receives and the higher the order of the modulation scheme, the higher the data rate may be for the UE 115. A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ−N_{f}) seconds, in which Δfₘₐₓ may represent the maximum supported subcarrier spacing, and N_{f} may represent the maximum supported discrete Fourier transform (DFT) size. Time intervals of a communications resource may be organized according to radio frames each having a specified duration (for example, 10 ms). Each radio frame may be identified by a system frame number (SFN) (for example, ranging from 0 to 1023).

Each frame may include multiple consecutively numbered subframes or slots, and each subframe or slot may have the same duration. In some examples, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol periods (for example, depending on the length of the cyclic prefix prepended to each symbol period). In some wireless communications systems 100, a slot may further be divided into multiple mini-slots containing one or more symbols. Excluding the cyclic prefix, each symbol period may contain one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, the number of symbol periods in a TTI) may be variable. Additionally or alternatively, the smallest scheduling unit of the wireless communications system 100 may be dynamically selected (for example, in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a number of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (for example, using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (for example, radio heads and ANCs) or consolidated into a single network device (for example, a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. In some examples of operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (for example, LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (for example, a base station 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (for example, antenna panels) to conduct beamforming operations for directional communications with a UE 115. Some signals (for example, synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to determine (for example, by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (for example, a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality compared to other measured beams.

In some examples, transmissions by a device (for example, by a base station 105 or a UE 115) may be performed using multiple beam directions, and the device may use a combination of digital precoding or radio frequency beamforming to generate a combined beam for transmission (for example, from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (for example, for determining a beam direction for subsequent transmission or reception by the UE 115) or for transmitting a signal in a single direction (for example, for transmitting data to a receiving device).

A receiving device (for example, a UE 115) may try multiple receive configurations (for example, directional listening) for receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (for example, for receiving a data signal). The single receive configuration may be aligned in a beam direction determined based on listening according to different receive configuration directions (for example, a beam direction determined to have a highest signal strength, highest signal-to-noise ratio (SNR), or otherwise acceptable signal quality based on listening according to multiple beam directions).

In the wireless communications system 100, a communication device (for example, a UE 115) may be a mobile communication device, such that the UE 115 may be able to move (for example, travel) throughout the geographic coverage area 110. A base station 105 may use different beams to support communications, such as downlink communications, with the UE 115 as the UE 115 travels through the geographic coverage area 110. In some examples, however, the UE 115 may not be aware that a beam change will occur and as such, may lose a connection with the base station 105 due to the beam change. To reduce the likelihood of disruptions in wireless communications between the UE 115 and the base station 105, the UE 115 may perform one or more beam change predictions using a machine learning model, such as an HMM, an LSTM neural network, a GRU neural network, a CNN, an RNN, or a DNN, among other examples.

For example, a UE 115 may receive, from a network node (for example, a base station or an access network entity), a reference signal associated with a beam of a set of beams used for wireless communications at the UE 115. Each beam of the set of beams may be associated with a respective beam index. The UE 115 may determine a probability associated with an adjustment of the beam. In some examples, the probability may indicate whether the beam will change over a duration from a first beam associated with a first beam index to a second beam associated with a second beam index based at least in part on the reference signal. The UE 115 may transmit, to the network node, an indication of the probability associated with the adjustment of the beam.

In some examples, the UE 115 may use a machine learning model, such as an HMM, an LSTM neural network, a GRU neural network, a CNN, an RNN, or a DNN, among other examples, to predict whether a beam change (for example, a beam adjustment) will occur at a future time or over a future duration. For example, the UE 115 may use the HMM to predict whether a beam change will occur (for example, over the future duration). In such an example, the beam change prediction may be based on information included in a model configuration, such as an HMM configuration, and measurements (for example, beam quality measurements) performed by the UE 115. The UE 115 may perform the measurements on signals (for example, reference signals) received from the base station 105 over one or more beam measurement cycle and use the measurement results as input for the model, such as an HMM (for example, with information included in the configuration such as an HMM configuration) to predict whether a beam change will occur at the future time or over the future duration. The UE 115 may indicate a beam change prediction (for example, an indication based on the output of the model) to the base station 105, and the base station 105 may use the beam change prediction in signaling to the UE 115 or for adjustments of the UE 115 (along with signaling to one or more other UEs 115 or for one or more adjustments of one or more other UEs 115).

In some examples, to increase the reliability of beam change predictions, the UE 115 may use the machine learning model, such as the HMM, the LSTM neural network, the GRU neural network, the CNN, the RNN, or the DNN, to estimate a probability (for example, a soft decision) of a beam change occurring at the future time or over the duration. The UE 115 may compare the estimated probability to a threshold to determine whether the beam change will occur (for example, a rigid decision). The UE 115 may indicate whether the beam change will occur (for example, the rigid decision) or the estimated probability (for example, the soft decision) to the base station 105. Predicting whether a beam change will occur at the future time may increase the reliability of communications between the UE 115 and the base station 105, as well as improve throughput and reduce latency for the UE 115.

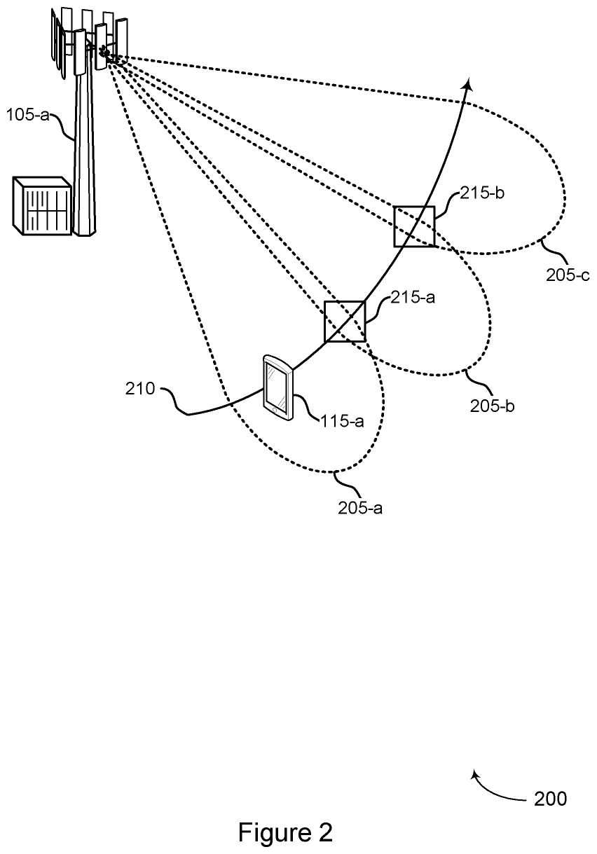

FIG. 2 illustrates an example of a wireless communications system 200 that supports signaling enhancement for beam change predictions via modeling in accordance with aspects of the present disclosure. The wireless communications system 200 may implement or be implemented by one or more aspects of the wireless communications system 100. For example, the wireless communications system 200 may include a UE 115-a and a base station 105-a, which may be examples of the corresponding devices as described in the present disclosure including with reference to FIG. 1.

The UE 115-a may be a mobile UE that can travel along a path 210. The UE 115-a may perform an initial access procedure to establish a connection with the base station 105-a. For example, while in a connected mode, the UE 115-a may receive downlink communications from the base station 105-a via a directional beam (for example, a beam 205-a, a beam 205-b, or a beam 205-c). As the UE 115-a travels along the path 210, the established connection (for example, a communication link that may also referred to as a radio link or a link) may be susceptible to blockages and degradation, which may cause interruptions in the radio link or a radio link failure (for example, downlink communications may be lost). To reduce the likelihood of radio link failures occurring or to recover after a radio link failure, the UE 115-a may perform beam management procedures, such as a beam failure prevention procedure or a beam failure recovery procedure.

For example, the UE 115-a may perform the beam failure recovery procedure to reestablish a connection with the base station 105-a and select another (for example, different) beam pair for communications with the base station 105-a. In some examples, the UE 115-a may perform beam management procedures, such as synchronization signal block (SSB) or CSI-RS beam sweeping, SSB and random access channel (RACH) occasion association (for example, with relatively wide beams, such as layer one (L1) beams), hierarchical beam refinement procedures (for example, P1/P2/P3 procedures for downlink beam management or UT/U2/U3 procedures for uplink beam management), and L1 reporting. In examples in which the UE 115-a detects interruptions in the radio link or a radio link failure, the UE 115-a may perform a recovery procedure (for example, a fast master cell group (MCG) link recovery procedure) to reduce a link interruption time or a link failure time. However, in some examples, the UE 115 may resort to (for example, determine to) perform a handover procedure.

To reduce the likelihood of interruptions in the radio link as the UE 115-a changes location (for example, as the UE 115-a travels along the path 210), the base station 105-a may switch (for example, change) the beam used for downlink communications with the UE 115-a. For example, the base station 105-a may use different beams to transmit downlink communications to the UE 115-a based on the location of the UE 115-a. The base station 105-a may use the beam 205-a to transmit downlink communications to the UE 115-a while the UE 115-a is located in a first region and a beam 205-b to transmit downlink communications to the UE 115-a while the UE 115-a is located in a second region (for example, an adjacent region).

In examples in which the UE 115-a travels to a location in which multiple beams overlap (for example, a location 215-a or a location 215-b), the base station 105-a may change a beam used to transmit downlink communications to the UE 115-a. For example, the base station 105-a may transmit downlink communications to the UE 115-a via the beam 205-a and the UE 115-a may travel along the path 210 to the location 215-a. In such an example, the base station 105-a may change beams (for example, from the beam 205-a to the beam 205-b) and transmit downlink communications to the UE 115-a via the beam 205-b. In some examples, the beam 205-a, the beam 205-b, and a beam 205-c may each be associated with a different beam index, also referred to as a beam indicator.

In some examples, the UE 115-a may not be aware that a beam change (for example, by the base station 105-a) may occur. As such, the UE 115-a may perform beam change predictions, for example with increased beam measurement cycles, reduced measurements, or artificial intelligence (AI) methods to predict the beam change. For example, as discussed above, the UE 115-a may perform beam management procedures to reduce the likelihood of link interruptions. In some examples, however, performing beam management procedures with reporting may unnecessarily consume overhead (for example, UE-specific overhead) and power at the UE 115-a. For example, the UE 115-a may perform beam management procedures with relatively frequent reporting (for example, at 20 ms or 40 ms time increments or durations). In some examples, the UE 115-a may report beam measurements (for example, as part of a beam management procedure) via fields of an information element (IE). For example, the UE 115-a may be configured (for example, via a CSI-ReportConfig IE) with a higher layer reporting parameter (for example, a reportQuantity IE) that may be used to report beam measurements. In some examples, the UE 115-a may set the higher layer reporting parameter to different values, such as with a ssb-Index-RSRP field to indicate a reference signal received power (RSRP) measurement of an SSB and a cri-RSRP field to indicate an RSRP measurement of a CSI-RS. In some examples, the UE 115-a may report (for example, in a channel state information (CSI) report) a resource indicator (RI), such as an SSB resource indicator (SSBRI) or a CSI-RS resource indicator (CRI), based on the value in which the higher layer reporting parameter is set to.

Additionally or alternatively, in stationary or low-speed scenarios where the UE 115-a is moving relatively slowly (for example, with a low speed walk), the beam index associated with a beam with a highest beam quality, a highest signal strength, or an otherwise acceptable signal quality (for example, relative to other detectable beams) may not change over a duration (for example, hundreds of ms). A beam with a highest beam quality, a highest signal strength, or an otherwise acceptable signal quality relative to other detectable beams may be referred to as a top beam. Additionally or alternatively, an index associated with a top beam may be referred to as a top beam index. In some examples, in relatively low speed scenarios, base station beams may be relatively stationary (for example, beams may be 90% unchanged over 20 ms beam measurement cycles) and beam management procedures may not need to be used. As such, it may be beneficial to reduce overhead or power consumption (for example, at the UE 115-a) by enabling the UE 115-a to predict whether a beam change will occur.

In some examples, the UE 115-a may predict whether the top beam may change (for example, may change from one beam to another beam, or additionally or alternatively may change dynamically at an increased rate) at a future time or over a future duration with increased beam measurement periodicity (for example, hundreds of ms rather than tens of ms) or with a reduced number of reference signal resources (for example, CSI-RS resources or SSB resources). For example, the UE 115-a may use 4 measured beams to predict a top beam out of 32 potential (for example, detectable) beams. Further, in examples in which the top beam is predicted to change or the rate of dynamic beam changes shifts (for example, increases), the UE 115-a may transmit requests to the base station 105-a for decreased beam measurement periodicity or increased reference signal resources. In examples in which the UE 115-a determines a stationary condition or a stationary state (for example, a state in which a beam change does not occur), beam management procedures (for example, beam management procedures with reporting via the ssb-Index-RSRP field or the cri-RSRP field) may be suspended.

In some examples, the UE 115-a may perform beam change predictions via a machine learning model, such as an HMM, an LSTM neural network, a GRU neural network, a CNN, an RNN, or a DNN, among other examples. For example, the UE 115-a may estimate a probability that a beam change will occur based on a machine learning model that may be determined at the UE 115-a or may be indicated to the UE 115-a by the network. In some examples, the probability associated with the beam change may be reported by the UE 115-a, independent of whether a machine learning model is configured for the UE 115-a by the network. For example, the UE 115-a may determine a machine learning model and use the determined machine learning model to predict whether a beam change will occur (for example, estimate a probability that a beam change will occur). In some examples, the UE 115-a may be configured with one or more machine learning models that the UE 115-a may train, for example using federated learning. In such examples, the UE 115-a may determine (for example, select) a machine learning model (for example, the UE may determine an HMM) to use for estimating the probability associated with the beam change by or based on measurements performed at the UE 115-a. Additionally or alternatively, the UE 115-a may estimate the probability associated with the beam change (or predict whether a beam change will occur based on the estimated probability) independent of a machine learning model.

In some examples, the network may configure the UE 115-a with a machine learning model to be used by the UE 115-a for predicting whether a beam change will occur. For example, the network may train one or more machine learning models and configure (for example, transmit an indication for) the UE 115-a to use one or more of the trained models for beam change predictions. In some examples, the network may train, such as through federated learning, a global HMM for beam change predictions or problems associated with beam changes. The global HMM, which may also be referred to as the HMM, may be a statistical model in which unobservable states of a system (for example, hidden states) may be predicted based on probabilities associated with the likelihood of a transition between states (for example, from one state to another), probabilities associated with the likelihood that an observation will occur given a state of the system (for example, a current hidden state) and observations (for example, measurements performed by the UE 115-a). In some examples, a state of the system may refer to whether a beam change will occur. For example, a state in which a beam change will not occur may be referred to as a static state and a state in which a beam change will occur may be referred to as a dynamic state. In some examples, probabilities associated with the likelihood of a transition between states may be referred to as transition probabilities and probabilities associated with the likelihood that an observation will occur given a state may be referred to as emission probabilities.

The machine learning model (for example, the HMM) may be updated for a UE, such as UE 115-a, depending on the trajectory of the UE 115-a (for example, the path 210) or locations of the UE 115-a while served by a particular base station (for example, the base station 105-a). In other words, different machine learning parameters or parameters included in a configuration of the machine learning model (for example, transition probabilities and emission probabilities that may be included in an HMM configuration) may be suitable for different trajectories of the UE 115-a or different positions of the UE 115-a. In some examples, configuration of (for example, pre-configuration) or dynamic updating of parameters associated with the machine learning model (for example, the HMM parameters or other parameters associated with other machine learning models) may be enabled to support beam change predictions at the UE 115-a. For example, techniques that support signaling enhancement for beam change predictions via modeling, as described in the present disclosure, may enable beam change predictions at the UE 115-a with reduced complexity and increased flexibility for model generalization.

In some examples, determinations of whether a beam change may occur (for example, a rigid decision) may be insufficient. For example, the UE 115-a may incorrectly predict that a beam change will occur and alter the behavior of the UE 115-a unnecessarily or the UE 115-a may unnecessarily expend power determining that no beam change will occur. In some examples, unnecessary changes in the behavior of the UE 115-a may result in increased power consumption and reduce link performance (for example, reduced throughput). Further, some methods for beam change predictions may be too rigid. For example, techniques which generate rigid decisions on the estimated hidden state (for example, whether the state is dynamic or static) may have a reduced flexibility relative to techniques which generate a soft decision (for example, a probability that a beam change will occur). As such, miss detection rates and false alarm rates for techniques which generate rigid decision based beam change predictions may be fixed, such that both power consumption and link performance may not be alterable. However, soft decision based beam change prediction via the machine learning model may enable an increased flexibility in the trade-off between power consumption for beam management and link performance.

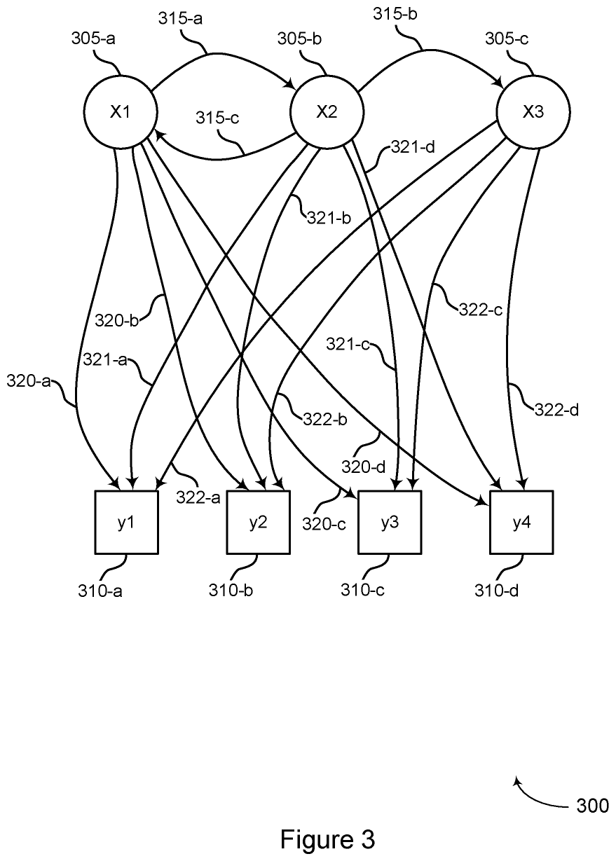

FIG. 3 illustrates an example of an HMM 300 that supports signaling enhancement for beam change predictions via modeling in accordance with aspects of the present disclosure. The HMM 300 may implement aspects of the wireless communications system 100 and the wireless communications system 200. For example, aspects of the HMM 300 may be implemented at, or implemented by, one or both of a base station 105 or a UE 115, which may be examples of the corresponding devices described with reference to FIGS. 1 and 2. The HMM 300 illustrates an example of a model (for example, an HMM of beam change prediction problems) which may be used by a communication device (for example, the base station 105 or the UE 115) to predict beam changes. The HMM 300 may be an example of an HMM described in the present disclosure, including with reference to FIG. 2.

The communication device may predict whether a beam change will occur via a machine learning model, such as via the HMM 300. In the example of FIG. 3, the HMM 300 illustrates components of an HMM which may include hidden states (for example, a hidden state 305-a, a hidden state 305-b, or a hidden state 305-c) and transition probabilities (for example, a transition probability 315-a, a transition probability 315-b, and a transition probability 315-c) that may control, or determine, the way a hidden state (X(t)) is chosen given a previous hidden state (X(t)−1). For example, the transition probability 315-a may be associated with the likelihood that the hidden state 305-b may be chosen given a previous hidden state of the hidden state 305-a. The HMM 300 may include observations (Y(t)) and emission probabilities (for example, or output probabilities) that may determine, or govern, the distribution of the observed variable (Y(t)) given a state of the hidden variable (X(t)), for example at a particular time. In some examples, a number of emission probabilities (for example, an emission probability 320-a, an emission probability 320-b, an emission probability 320-c, and an emission probability 320-d) may be associated with an observation 310-a, a number of emission probabilities (for example, an emission probability 321-a, an emission probability 321-b, an emission probability 321-c, and an emission probability 321-d) may be associated with an observation 310-b, and a number of emission probabilities (for example, an emission probability 322-a, an emission probability 322-b, an emission probability 322-c, and an emission probability 322-d) may be associated with an observation 310-c.

In some examples, to reduce overhead and power consumption, a communication device (for example, the UE 115) may use the HMM 300 to predict whether a beam change will occur at a future time or over a future duration. For example, the HMM 300 may be used for beam change predictions by defining a hidden state (for example, a value of the hidden state variable (X(t)), for the case in which the beam change will not occur (for example, a static state) and a hidden state for the case in which the beam change will occur (for example, a dynamic state). For example, given an observation, which may be an input, of a number of measured reference signals, the state X(t)=1 may represent a case in which a top beam change will not occur over a duration (for example, t to t+N) and the state X(t)=2 may represent a case in which the top beam change will occur over the duration. In some examples, the top beam change may refer to a change in the beam index of a top beam. For example, a top beam may change from a first beam with a first beam index to a second beam with a second beam index. In some examples, the input for the HMM may include a beam quality measurement value, such as an RSRP value (for example, an L1-RSRP value) or a signal-to-interference-plus-noise ratio (SINR) value (for example, an L1-SINR value), for each of the measured reference signals.

In some examples, an observation (for example, an observation 310-a, an observation 310-b, an observation 310-c, or an observation 310-d) may be defined for a set of K beams used to transmit the measured reference signals (for example, K SSB beams) and observation (Y(t)) may be defined according to Equation (1):

$$Y ( t ) \{ {B}_{1} ( t ) , … , {B}_{K} ( t ) , RSRP ( t ) , … , RSRP ( t ) \} , \qquad ( 1 )$$

in which Bₖ(t)∈{1, 2, . . . , K} may represent an index associated with a kth top beam, for example the kth beam with a highest beam quality measurement value (for example, a strongest RSRP value or SINR value) compared to beam quality measurement values of a number (K) of other measured beams. Additionally or alternatively, transition probabilities may be defined according to Equation (2):

$$P r ( X ( t ) = i \vert X ( t - 1 ) = j ) , \qquad ( 2 )$$

in which i,j ∈{1,2} and emission probabilities may be defined according to Equation (3):

$$P r ( Y ( t ) = {Y}_{C} \vert X ( t ) = i ) \qquad ( 3 )$$

in which Y_{c} ∈C and C may be a measurable set associated with the observations and i∈{1,2}.

In some examples, using estimated or base station signaled transition probabilities and emission probabilities, the UE 115 may obtain, or estimate, the hidden states X(t) based on observation Y(t). In other words, the UE 115 may estimate whether the top beam change will occur at the future time or over the future duration, based on transition probabilities, emission probabilities, and observations Y(t). In some examples, transition probabilities and emission probabilities may be estimated via samples of observations and related ground truth hidden state labels (for example, measurements) using an expectation-maximization (EM) algorithm, such as a Baum-Welch algorithm. In some examples, a hidden state estimation may be obtained via dynamic programming algorithms, such as a Viterbi algorithm.

In some examples, the number (M) of hidden states may be more than 2. In such examples, the number of transition probabilities may be determined according to Equation (4) and the number of emission probabilities may be determined according to Equation (5):

$$M \times M \qquad ( 4 )$$

$$M \times \vert {Y}_{C} \vert \qquad ( 5 )$$

The number of hidden states beyond 2 (for example, the additional M-2 hidden states), may include transitional states. In some examples, the transitional hidden states may include a transitional state which suggests a status (for example, associated with the top beam change) between a stationary state and a dynamic state. In some examples, the transitional states may include states (for example, different states) which indicate beams (for example, other top beams) in which the top beams may switch to. In some examples, the indicated beams may be associated with SSBRIs or CRIs of the top beams. In some examples, the UE 115 may report an estimated state (for example, an estimated (m) state of M hidden states) to the base station 105. In such examples, decisions regarding the adjustment of beam management procedures at the base station 105 may be improved.

Although the example of FIG. 3 has been described in the context of an HMM, it is to be understood that the communication device may predict whether a beam change will occur via other machine learning models, such as via an LSTM neural network, a GRU neural network, a CNN, an RNN, or a DNN, among other examples.

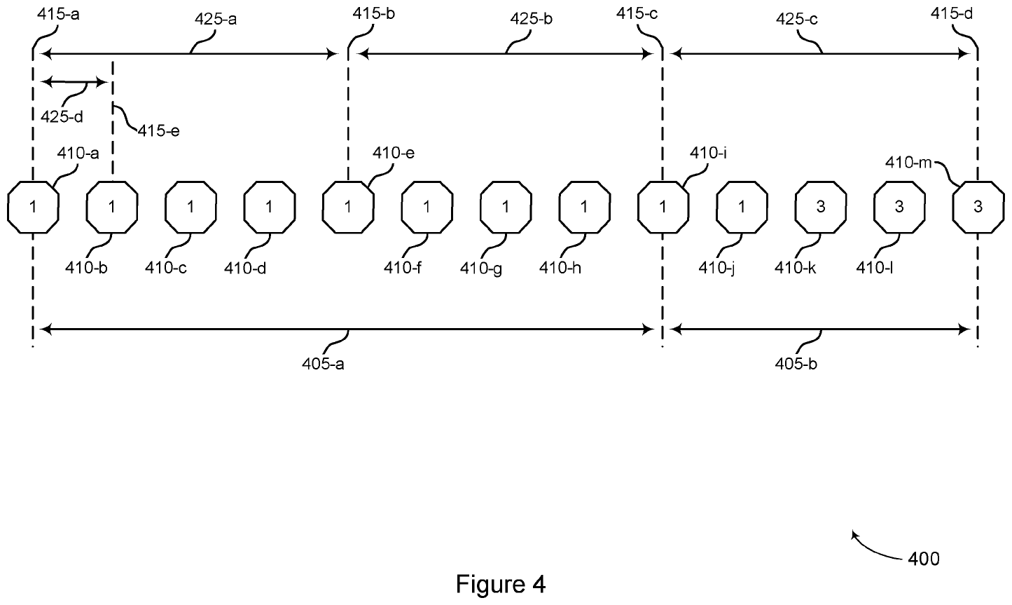

FIG. 4 illustrates an example of a beam change prediction procedure 400 that supports signaling enhancement for beam change predictions via modeling in accordance with aspects of the present disclosure. The beam change prediction procedure 400 may implement aspects of the wireless communications system 100 and the wireless communications system 200. For example, aspects of the beam change prediction procedure 400 may be implemented at, or implemented by, one or both of a base station 105 or a UE 115, which may be examples of the corresponding devices described with reference to FIGS. 1 and 2.

For example, a communication device (for examples, the base station 105 or the UE 115) may implement the beam change prediction procedure 400 using a machine learning model for beam change predictions. The machine learning model may be an example of an HMM, an LSTM neural network, a GRU neural network, a CNN, an RNN, or a DNN, among other examples. The HMM may be an example of the HMM 300 described with reference to FIG. 3. In some examples (for example, if the machine learning model used by the UE is the HMM), the UE 115 may be configured, via the HMM configuration, with transition probabilities and emission probabilities associated with, or regarding, an HMM to predict a top beam change. The beam change predictions may be based on beam measurements (for example, RSRP measurements or SINR measurements) associated with a number of reference signal resources (for example, CSI-RS resources or SSB resources) measured in a beam measurement cycle (for example, a first beam measurement cycle).

For example, the UE 115 may use information (for example, the transition probabilities and the emission probabilities or other information that may be used at input for a machine learning model) to determine whether the top beam change will occur at a future time or over a future duration based on measurements preformed over the first beam measurement cycle and whether the top beam change occurred over a second duration. In some examples, the top beam change may be defined as whether a beam indicator (for example, a beam index) associated with a highest measured beam quality metric value (for example, a strongest measured beam quality metric value, a highest signal strength, or an otherwise acceptable signal quality) compared to other measured beams will change in a duration (for example, over the future duration) compared to the beam index associated with a highest beam quality metric value in a beam measurement cycle prior to the duration (for example, a current beam measurement cycle). A beam index may refer to an SSBRI or a CRI and a beam quality metric value may refer to an RSRP value or an SINR value. In other words, using the information, together with the observation including the top beam index (for example, B₁(t)=SSBRI) and the associated measured beam quality metric (for example, RSRP₁(t)), the UE 115 may estimate whether the top beam change will occur (for example, a state X(t)) over the future duration.

In some examples, at a beam measurement occasion (for example, a beam measurement occasion 415-c) the UE 115 may determine whether the top beam change (for example, a change in the beam index associated with the top beam) will occur over the future duration (for example, the duration 405-b) or at a future beam measurement occasions (for example, a beam measurement occasion 415-d) based on the information, the beam measurement results (for example, a beam index of 1 as illustrated by a beam measurement result 410-i), and (for example, optionally) one or more previous measurement results (for example, one or more of a beam measurement result 410-a, a beam measurement result 410-b, a beam measurement result 410-c, a beam measurement result 410-d, a beam measurement result 410-e, a beam measurement result 410-f, a beam measurement result 410-g, or a beam measurement result 410-h). The UE 115 may predict whether future beam measurement results (for example, a beam measurement result 410-j, a beam measurement result 410-k, a beam measurement result 410-l, or a beam measurement result 410-m) may be different relative to the measured (for example, current) beam measurement results (for example, the beam measurement result 410-i).

In some examples, a duration associated with a beam measurement cycle may be variable (for example, 20 ms, 40 ms, 80 ms, or 160 ms). In other words, beam measurement occasions (for example, a beam measurement occasion 415-a, a beam measurement occasion 415-b, the beam measurement occasion 415-c, a beam measurement occasion 415-d, or a beam measurement occasion 415-e) may occur at different periodicities. In some examples, beam measurements (for example, performed at the beam measurement occasion 415-e with a periodicity of 20 ms) may be used to determine a ground truth for predicting whether a beam change may occur (for example, may be used as input for the machine learning model). Additionally or alternatively, a duration associated with a duration (for example, over which a beam change may or may not occur) may be variable (for example, 20 ms, 40 ms, 80 ms, or 160 ms).

In some examples, the duration associated with the beam measurement cycle may be equal to or different than the duration associated with the duration. For example, a duration associated with the first beam measurement cycle (for example, the beam measurement cycle 425-b) may be equal to a duration associated with a second beam measurement cycle (for example, the beam measurement cycle 425-a), a duration associated with another beam measurement cycle (for example, a beam measurement cycle 425-c), and a duration associated with the second duration (for example, the duration 405-b). In another example, the duration (for example, 80 ms) associated with the second beam measurement cycle (for example, the beam measurement cycle 425-b) may be different than the duration (for example, 20 ms) associated with another beam measurement cycle (for example, a beam measurement cycle 425-d). Additionally or alternatively, the duration (for example, 160 ms) associated with the second duration (for example, the duration 405-a) may be different than a duration (for example, 80 ms) associated with a first duration (for example, the duration 405-b).

The timing relationships among (for example, or between) the first beam measurement cycle, the second beam measurement cycle, the first duration, and the second duration may be predefined (for example, in an industry standard or other regulation), preconfigured (for example, in one or more of the communication devices such as the 115 or the base station 105), configured (for example, via signaling from a base station 105), dynamically indicated (for example, via signaling from the base station 105), or based on an indication, such as a recommendation, transmitted by the UE 115 to the base station 105 and then the base station 105 may indicate or otherwise provide a configuration to the UE 115. Additionally or alternatively, the timing relationships may include the durations, durations of the beam measurement cycles, time intervals between components (for example, two different components) of the beam measurement cycles or time intervals between components of the durations.

In some examples, the UE 115 may be configured to update (or alter) one or more aspects of the beam change prediction procedure 400. For example, the UE 115 may be configured or indicated (for example, via application layer signaling, radio resource control (RRC) signaling, downlink control information (DCI) signaling, or medium access control control element (MAC-CE) signaling) to alter information used as input for a machine learning model (for example, one or multiple probabilities of the transition probabilities, one or multiple probabilities of the emission probabilities), the timing relationships among (for example, or between) the beam measurement cycles and the durations, the number of considered (for example, measured) reference signal beams (for example, SSB beams or CSI-RS beams), or the particular reference signal beams to be accounted for (for example, measured). Additionally or alternatively, the indication (for example, dynamic indication) or configurations (for example, or pre-configurations) may be based on a position or a trajectory of the UE 115. In some examples, the position or the trajectory of the UE 115 may be based on position information or trajectory information reported by the UE 115. In some examples, the position or the trajectory of the UE 115 may be based on determinations made by the base station 105.

For scenarios in which the UE 115 may perform beam change predictions via an HMM, the emission probabilities and the transition probabilities may be examples of the respective probabilities described in the present disclosure, including with reference to FIG. 3. In some examples, the transition probabilities and the emission probabilities may each be associated with the first beam measurement cycle (for example, a beam measurement cycle 425-b), the future duration (for example, the first duration, a duration 405-b) after or subsequent to the first beam measurement cycle, the second beam measurement cycle (for example, a beam measurement cycle 425-a) preceding the first beam measurement cycle and the second duration (for example, a duration 405-a) subsequent to, or overlapping with, the second beam measurement cycle. In some examples, the first duration may occur after, or subsequent to, the first beam measurement cycle.

For example, the transition probabilities may be defined according to one or multiple of Equations 6-9:

$$P r ( X ( t ) = 1 \vert X ( t - 1 ) = 1 ) , \qquad ( 6 )$$

$$Pr ( X ( t ) = 2 \vert X ( t - 1 ) = 1 ) , \qquad ( 7 )$$

$$Pr ( X ( t ) = 1 \vert X ( t - 1 ) = 2 ) , \qquad ( 8 )$$

$$Pr ( X ( t ) = 2 \vert X ( t - 1 ) = 2 ) , \qquad ( 9 )$$

in which Equation 6 may represent a probability that a beam index associated with a highest measured beam quality metric value (for example, a strongest measured beam quality metric value, a highest signal strength, or an otherwise acceptable signal quality) compared to other measured beams in the first beam measurement cycle will not change, while the beam index associated with the highest measured beam quality metric value in the second duration did not change compared to the beam index associated with the highest measured beam quality metric value measured in the second beam measurement cycle.

Equation 7 may represent a probability that a beam index associated with a highest measured beam quality metric value (for example, a strongest RSRP value or SINR value compared to other measured RSRP values or other measured SINR values) in the first beam measurement cycle will change, while the beam index associated with the highest measured beam quality metric value in the second duration did not change compared to the beam index associated with the highest measured beam quality metric value measured in the second beam measurement cycle. Equation 8 may represent a probability that a beam index associated with a highest measured beam quality metric value in the first beam measurement cycle will not change, while the beam index associated with the highest measured beam quality metric value in the second duration did change compared to the beam index associated with the highest measured beam quality metric value measured in the second beam measurement cycle. Equation 9 may represent a probability that a beam index associated with a highest measured beam quality metric value in the first beam measurement cycle will change, while the beam index associated with the highest measured beam quality metric value in the second duration did change compared to the beam index associated with the highest measured beam quality metric value measured in the second beam measurement cycle.

Additionally or alternatively, the emission probabilities may be associated with the results (for example, the beam quality metric values) measured over the first beam measurement cycle. For examples, the results may be regarding (for example, correspond to) the beam indices associated with the highest measured beam quality metric values (for example, of a number of measured beams) and the respective beam quality metric values. For example, the emission probabilities may be defined according to one or both of Equations 10 and 11:

$$P r ( X ( t ) = 1 \vert X ( t - 1 ) = 2 ) , \qquad ( 10 )$$

$$Pr ( X ( t ) = 2 \vert X ( t - 1 ) = 2 ) , \qquad ( 11 )$$

in which Equation 10 may represent a probability that the results measured over the first beam measurement cycle, given that the beam index associated with the highest measured beam quality metric values in the first duration will not change compared to the beam index associated with the highest measured beam quality metric values measured in the first beam measurement cycle. Equation 11 may represent a probability that the results measured over the first beam measurement cycle, given that the beam index associated with the highest measured beam quality metric values in the first duration will change compared to the beam index associated with the highest measured beam quality metric values measured in the first beam measurement cycle.

The UE 115 may report beam change predictions (or probabilities that a beam change will occur) to the network. For example, the UE 115 may report the probability that a beam change will occur based on one or more methods. In some examples, the UE 115 may report the probability that a beam change will occur within a same CSI report as may be used to indicate channel characteristics (for example, measured by the UE 115) to the network. For example, the UE 115 may report the probability in a CSI report that may carry L1-RSRP or L1-SINR measurements (for example, performed on network configured reference signals). In such an example, a periodicity associated with reporting the probability may match the beam management periodicity (for example, a periodicity associated with a beam management procedure performed by the network).

Additionally, or alternatively, the UE 115 may report the probability via a separate CSI report. For example, the UE 115 and the network may implement multiple CSI report settings, such as separate CSI report settings for reporting measured channel characteristics and predicted channel characteristics, such as beam change predictions (for example, estimated probabilities that a beam change will occur). For example, the network may configure the UE 115 with the multiple CSI reporting settings and the UE 115 may transmit separate CSI reports for measured channel characteristics and beam change predictions to the network based on separate CSI report settings for measured and predicted channel characteristics. In some examples, by using the multiple CSI report settings, CSI reports for measured channel characteristics and CSI reports for predicted beam changes may each have relatively lower overhead and relatively smaller payloads, for example compared to a CSI report that may be used to report both predicted beam changes and measured channel characteristics. As an illustrative example, the UE 115 may transmit a first CSI report that indicates one or more measured channel characteristics (for example, of a channel used for the wireless communications between the UE 115 and the network) and a second CSI report that indicates a probability that a beam change will occur.

In some examples, the UE 115 may determine whether requests to refine channel state reporting parameters (for example, parameters configured via a CSI-ReportConfig 1E) may be sent based on the beam change prediction. For example, the UE 115 may request to increase or decrease the report periodicity (for example, associated with the CSI-ReportConfig 1E) or trigger one or multiple additional reports (for example, dynamic, persistent, or semi-persistent CSI reports). In some examples, the UE 115 may request to increase or decrease the number of reference signal resources (for example, CSI-RS resources or SSB resources) associated with the report configuration, such as indicate via the CSI-ReportConfig 1E. In some examples, the UE 115 may report a predicted beam change incident or suggest (for example, indicate) that the rate at which a top beam index is predicted to change may increase (for example, more dynamically compared to the previously reported top beam indices).

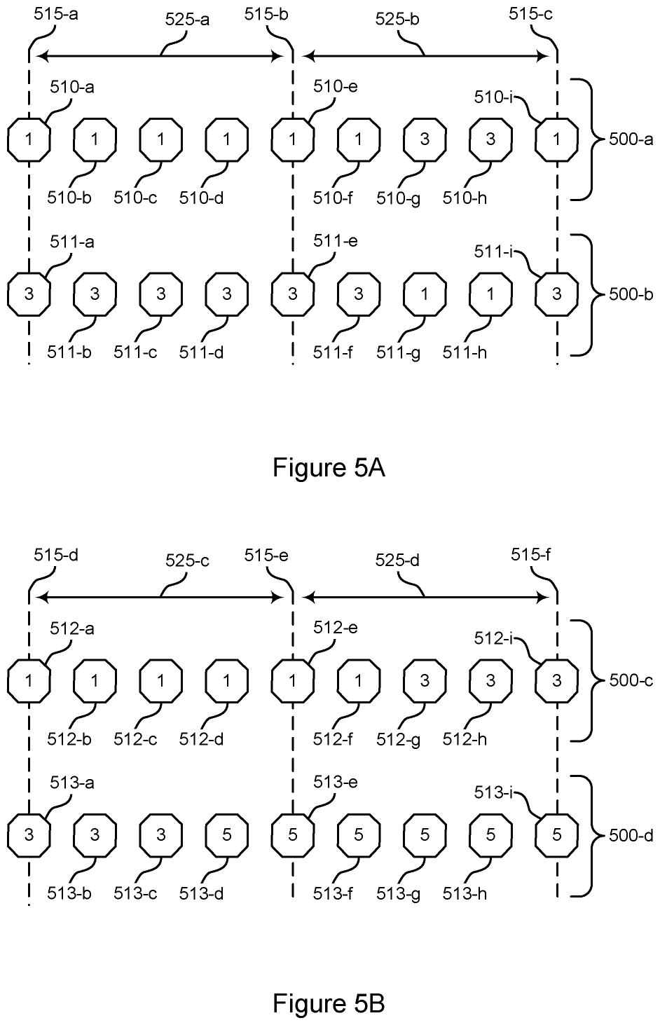

FIGS. 5A and 5B illustrate examples of beam change prediction procedures 500 that supports signaling enhancement for beam change predictions via modeling in accordance with aspects of the present disclosure. The beam change prediction procedures 500 (for example, a beam change prediction procedure 500-a, a beam change prediction procedure 500-b, a beam change prediction procedure 500-c, and a beam change prediction procedure 500-d) may implement aspects of the wireless communications system 100 and the wireless communications system 200. For example, aspects of the beam change prediction procedures 500 may be implemented at, or implemented by, one or both of a base station 105 or a UE 115, which may be examples of the corresponding devices described with reference to FIGS. 1 and 2.

In some examples, techniques which generate a rigid decision based beam change prediction (for example, whether a beam change will occur) may have a reduced flexibility relative to techniques which generate a soft decision (for example, a posteriori probability that a beam change will occur). That is, soft decision based beam change predictions via a machine learning model (for example, an HMM, an LSTM neural network, a GRU neural network, a CNN, an RNN, a DNN) may enable an increased flexibility in the trade-off between power consumption for beam management and link performance. For example, a communication device (for example, the UE 115) may be configured to predict, via the machine learning model (for example, based on machine learning model configuration, such as an HMM configuration), a probability (for example, the posteriori probability) that a beam index associated with a highest measured beam quality metric value (for example, a strongest measured beam quality metric value, a highest signal strength, or an otherwise acceptable signal quality) compared to other measured beams will change in a duration compared to the measured beam index associated with the highest measured beam quality metric value measured in a beam measurement cycle which occurs prior to the duration.

In some examples, the beam index may refer to a SSBRI or a CRI and a highest measured beam quality metric value may refer to a strongest RSRP value or a strongest SINR value compared to other measured RSRP values or other measured SINR values. For example, beams associated with the highest measured beam quality metric value, or values, may be referred to as top beams which may be examples of the top beams described in the present disclosure including with reference to FIGS. 3 and 4. That is, the UE 115 may predict the probability that a top beam change may occur at a future time or over a future duration based on the machine learning model (for example, the machine learning model configuration) and measurements performed over a beam measurement cycle. In some examples, the machine learning model may be an HMM. In such examples, the UE 115 may predict the probability that a top beam change may occur based on an HMM configuration that may include transmission probabilities and emission probabilities. The transmission probabilities and the emission probabilities may be examples of the respective probabilities described in the present disclosure, including with reference to FIG. 3.

In some examples, determining whether the top beam change will occur may be based on a capability of the UE 115 to estimate the probability of the predicted top beam changes. In some examples, the UE 115 may report the capability to base station 105. For example, the UE 115 may indicate to the base station 105, whether the UE 115 may determine (for example, calculate) the probability that the top beam change will occur at the future time or in the future duration.

In some examples, the UE 115-a may predict the probability that the top beam change may occur for multiple beams. As illustrated in the example of FIG. 5A, the UE 115-a may predict (for example, at a beam measurement occasion 515-b) the probability that the top beam change for a first beam (for example, illustrated by the beam change prediction procedure 500-a) and a second beam (for example, illustrated by the beam change prediction procedure 500-b) will occur over the future duration (for example, associated with a beam measurement cycle 525-b) or at future beam measurement occasions (for example, a beam measurement occasion 515-c) based on the machine learning model and the beam measurement results measured at the beam measurement occasion 515-b (for example, current beam measurement results). In some examples, the predicted probability may depend on one or more beam measurement results measured over a beam measurement cycle 525-a or at a beam measurement occasion 515-a (for example, one or more previous beam measurement results). For example, the predicted probability of the top beam change associated with the first beam may depend on a beam measurement result 510-a, a beam measurement result 510-b, a beam measurement result 510-c, and a beam measurement result 510-d. Additionally or alternatively, the predicted probability of the top beam change associated with the second beam may depend on one or more of a beam measurement result 511-a, a beam measurement result 511-b, a beam measurement result 511-c, or a beam measurement result 511-d.

For example, the UE 115 may predict, for the first beam, a probability that future beam measurement results (for example, a beam measurement result 510-f, a beam measurement result 510-g, a beam measurement result 510-h, or a beam measurement result 510-i) will be different relative to the measured (for example, current) beam measurement results (for example, the beam measurement result 510-e). Additionally or alternatively, the UE 115 may predict, for the second beam, a probability that future beam measurement results (for example, a beam measurement result 511-f, a beam measurement result 511-g, a beam measurement result 511-h, or a beam measurement result 511-i) will be different relative to the beam measurement result 511-e.

In some examples, the UE 115-a may determine, based on the predicted probabilities, that a future top beam index associated with the first beam (for example, the value associated with the beam measurement result 510-i) may be equal to a measured top beam index associated with the second beam (for example, the value associated with the beam measurement result 511-e). Additionally or alternatively, the UE 115 may determine that a future top beam index associated with the second beam (for example, the value associated with the beam measurement result 511-i) may be equal to a measured top beam index associated with the first beam (for example, the value associated with the beam measurement result 510-e). In other words, the UE 115 may predict the top beam change in which the respective top beam index associated with two top beams (for example two beam with similar RSRP levels) will switch values.

As illustrated in the example of FIG. 5B, the UE 115-a may predict (for example, at a beam measurement occasion 515-e) the probability that the top beam change for the first beam (for example, illustrated by the beam change prediction procedure 500-c) and the second beam (for example, illustrated by the beam change prediction procedure 500-d) will occur over the future duration (for example, associated with a beam measurement cycle 525-d) or at future beam measurement occasions (for example, a beam measurement occasion 515-f) based on the machine learning model and the beam measurement results measured at a beam measurement occasion 515-e (for example, current beam measurement results). In some examples, the predicted probability may depend on one or more beam measurement results measured over a beam measurement cycle 525-c or at a beam measurement occasion 515-d (for example, previous beam measurement results). For example, the predicted probability of the top beam change associated with the first beam may depend on one or more of a beam measurement result 512-a, a beam measurement result 512-b, a beam measurement result 512-c, or a beam measurement result 512-d. Additionally or alternatively, the predicted probability of the top beam change associated with the second beam may depend on one or more of a beam measurement result 513-a, a beam measurement result 513-b, a beam measurement result 513-c, or a beam measurement result 513-d.

For example, the UE 115 may predict, for the first beam, a probability that future beam measurement results (for example, a beam measurement result 512-f, a beam measurement result 512-g, a beam measurement result 512-h, or a beam measurement result 512-i) will be different relative to the beam measurement result 512-e. Additionally or alternatively, the UE 115 may predict, for the second beam, a probability that future beam measurement results (for example, a beam measurement result 513-f, a beam measurement result 513-g, a beam measurement result 513-h, or a beam measurement result 513-i) will be different relative to the beam measurement result 513-e.

In some examples, the UE 115-a may determine, based on the predicted probabilities, that a future top beam index associated with the first beam (for example, the value associated with the beam measurement result 511-i) may be different than the measured top beam index associated with the second beam (for example, the value associated with the beam measurement result 513-e). Additionally or alternatively, the UE 115 may determine that a future top beam index associated with the second beam (for example, the value associated with the beam measurement result 513-i) may be different than the measured top beam index associated with the first beam (for example, the value associated with the beam measurement result 512-e). In other words, the UE 115 may predict a top beam change in which the respective top beam index associated with two top beams will not switch. In some examples, a probability associated with the top beam change in which the respective top beam index associated with two top beams switch values may be smaller than a probability associated with a top beam change in which the respective top beam index associated with two top beams do not switch values.

In some examples, the UE 115 may compare the determined probability (for example, the soft decision) to a threshold to determine whether the top beam change will occur (for example, the rigid decision). That is, the UE 115 may use a threshold for determining a state, such as a static state or a dynamic state. The threshold may, in some examples, be configured for the UE by the network. For example, the network may configure the UE 115 with one or more thresholds may be associated with one or more machine learning models (for example, each threshold may be associated with a respective machine learning model or a threshold may be associated with multiple machine learning models).

In examples in which the determined probability satisfies the threshold, the UE 115 may determine that the top beam will change at the future time (for example, the state is dynamic). In some examples, the UE 115 may be configured (for example, pre-configured) or dynamically updated with the threshold to determine whether the top beam will change. In some examples, the UE 115 may recommend (for example indicated) the threshold to the base station 105 prior to being configured or updated with the threshold (for example, or prior to receiving an indication of a machine learning model, or a configuration for a machine learning model, such as an HMM configuration). The threshold may be a value between 0 and 1.

In some examples, the UE 115 may use the threshold to increase the flexibility of the trade-off between power consumption and throughput performance (for example, link performance). For example, the UE 115 may be configured (for example, pre-configured) with multiple (for example, different) thresholds. In such an example, the UE 115 may select a threshold based on a desired performance. In examples in which the UE 115 increases the value of the threshold, the likelihood that the UE 115 will predict a top beam change may decrease and the frequency in which the UE 115 performs beam measurements may also decrease. As a result, the power consumed by the UE 115 (for example, to perform beam measurements) may be reduced. However, in examples in which the UE 115 decreases the value of the threshold, the likelihood that the UE 115 will predict a top beam changes may increase and the frequency in which the UE 115 performs beam measurements may also increase. As a result, the link performance at the UE 115 may increase. As such, the UE 115 may increase the flexibility of the trade-off between power consumption and link performance by changing the value of the threshold.

In some examples, the UE may be configured with multiple thresholds associated with different hidden states (for example, different hidden states in which the UE 115 may predict a probability). For example, the UE may be configured with a first threshold associated with a first respective state, such as the stationary state (for example, or a static state), a second threshold associated with a second respective state, such as the dynamic state, and a third threshold associated with a third respective state, such as a transitional state. In such an example, the UE 115 may determine a state with a probability (for example, a maximum probability or a highest probability compared to other configured probabilities) and whether the determined state may be determined by comparing the estimated probability to the respective threshold. For example, the UE 115 may determine whether the dynamic state may be determined by comparing the estimated probability to the first threshold. In other words, for examples in which the estimated probability (for example, the output from the machine learning model) satisfies the first threshold, the UE 115 may determine whether a beam change will occur (for example, the dynamic state). In examples in which the estimated probability does not satisfy the first threshold, the UE 115 may proceed to (for example, determine) a next state (for example, until the UE 115 determines a state with a lowest probability compared to the other configured probabilities).

In some examples, the UE 115 may report a soft decision (for example, the estimated probability that the top beam change will occur) or a rigid decision (for example, whether the top beam change will occur) to the base station 105. For example, the UE 115 may report the soft decision or the rigid decision (for example, based on the soft decision or otherwise) in a CSI report (for example, via the ssb-Index-RSRP field, the ssb-Index-SINR field, the cri-RSRP field, or the cri-SINR field of the reportQuantity IE). In some examples, the number of measured reference signals (for example, SSBs) to be reported to the base station 105 may be indicated to the UE 115 (for example, via an RRC message through the nrofReportedRS field). That is, for examples in which the nrofReportedRS field is set equal to a number (R), the UE 115 may report a measurement (for example, through the ssb-Index-RSRP field via the reportQuantity IE) for R measured reference signals. Additionally or alternatively, the UE 115 may report the threshold used to determine whether the top beam change will occur (for example, whether the state is dynamic or static). For example, the UE 115 may report the threshold prior to, at the time of, or after determining the top beam change. In some examples, the UE 115 may report the threshold via the RRC message (for example through the reportQuantity IE).

In some examples, the UE 115 may report the probability based on multiple hidden states (for example, the UE 115 may report probabilities associated with one or multiple of the dynamic state, the static state, or other transitional states). In such examples, the UE 115 may report an identifier associated with the state (for example, a state ID) and the respective probability of the state (for example, a maximum probability or a highest probability compared to other configured probabilities).

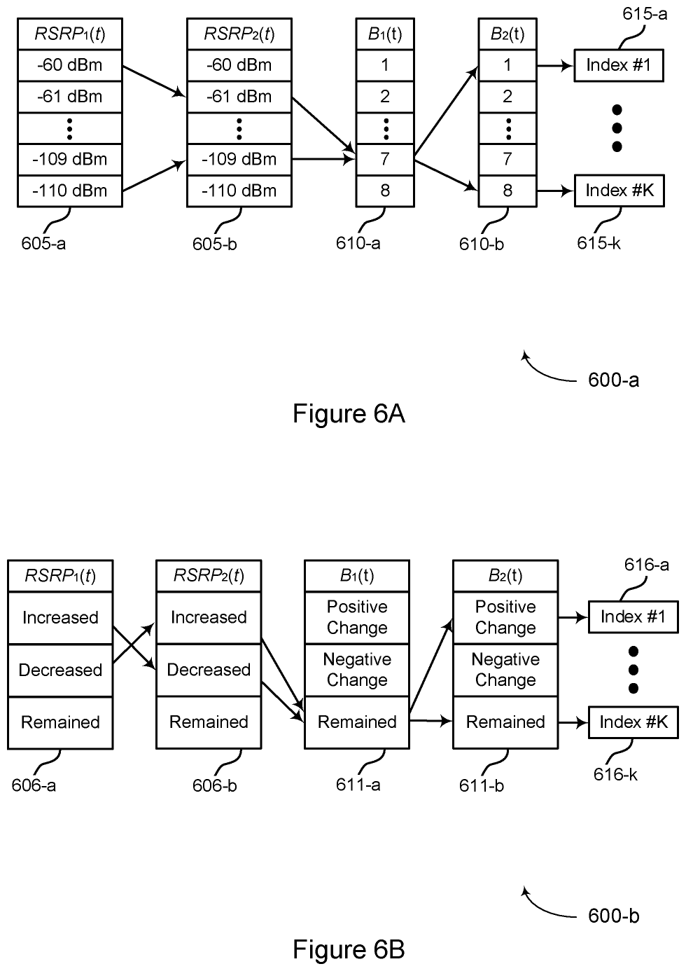

FIGS. 6A and 6B illustrate examples of result sequences 600 that supports signaling enhancement for beam change predictions via modeling in accordance with aspects of the present disclosure. The result sequences 600 (for example, a result sequence 600-a and a result sequence 600-b) may implement aspects of the wireless communications system 100 and the wireless communications system 200. For example, aspects of the result sequences 600 may be implemented at, or implemented by, one or both of a base station 105 or a UE 115, which may be examples of the corresponding devices described with reference to FIGS. 1 and 2.

In some examples, a communication device (for example, the UE 115) may use a machine learning model, such as an HMM, an LSTM neural network, a GRU neural network, a CNN, an RNN, or a DNN, among other examples, to predict whether a top beam change will occur (for example, a rigid decision) or a probability that the top beam change will occur (for example, a soft decision) based on the machine learning model (for example, a configuration of the machine learning model, such as an HMM configuration) and results measured over a first beam measurement cycle. The first beam measurement cycle may be an example of a first beam measurement cycle described in the present disclosure including with reference to FIGS. 3, 4, 5A, and 5B. For example, the results measured over the first beam measurement cycle may include a number of beam indicators (for example, beam indices), each corresponding to a top beam. The beam indices may include SSBRIs or CRIs. For examples in which the machine learning model is an HMM, the HMM configuration may be an example of an HMM configuration described in the present disclosure including with reference to FIG. 3.

Additionally or alternatively, the results measured over the first beam measurement cycle may include a beam quality metric value (for example, the measured RSRP value or the measured SINR value for each top beam) corresponding to each beam index. In some examples, the corresponding beam quality metric value may be rounded to an integer value (for example, a 5th dBm or a 10th dBm). In other words, the results measured over the first beam measurement cycle may include the beam index associated with each top beam and the corresponding beam quality metric value. For example, as illustrated in the example of FIG. 6A, the results (for example, or results sequence) may include measured beam quality metric values 605 (for example, a measured beam quality metric value 605-a and a measured beam quality metric value 605-b) and beam indices 610 (for example, a beam index 610-a and a beam index 610-b) for each top beam of a number (K) of top beams. In some examples, each results sequence may be identified by combinatorial indices 615 (for example, a combinatorial 615-a through a combinatorial 615-k).

In examples, the results may include an indication of whether the beam index associated with each top beam changed or remained the same over the first beam measurement cycle compared to the beam index associated with the top beams over the second beam measurement cycle. In examples in which the beam index associated with one or multiple of the top beams changed, the results may indicate how many beam indices (for example, SSB beam indices or CSI-RS beam indices) each top beam changed by. That is, the results may indicate a difference in the top beam index of the top beams in which the beam changed from the second beam measurement cycle and the first beam measurement cycle. In some examples, the input (for example, for the machine learning model) may be labelled to indicate the difference (for example, a first top beam changed with an SSB beam index of +4). Additionally or alternatively, the results may indicate whether the corresponding beam quality metric values increase, decreased, or remained the same over the first beam measurement cycle compared to the beam quality metric values measured over the second beam measurement cycle. In some examples, the indication of whether the measured beam quality metric value changed (for example, the increased indication, the decrease indication, or the remained indication) may be based on a comparison of the filtered (for example, averaged) beam quality metric value measured over multiple (for example, instantaneous) beam measurement cycles.

In some examples, as illustrated in the example of FIG. 6B, each results sequence (for example, identified by a combinatorial index 616-a through a combinatorial index 616-k) may include an indication of whether the measured beam quality metric value changed (for example, a beam quality metric indication 606-a or a beam quality metric indication 606-b). Additionally or alternatively, each results sequence may include an indication of whether the beam index associated with each top beam changed (for example, a beam change indication 611-a or a beam change indication 611-b) for each top beam of the number (K) of top beams.

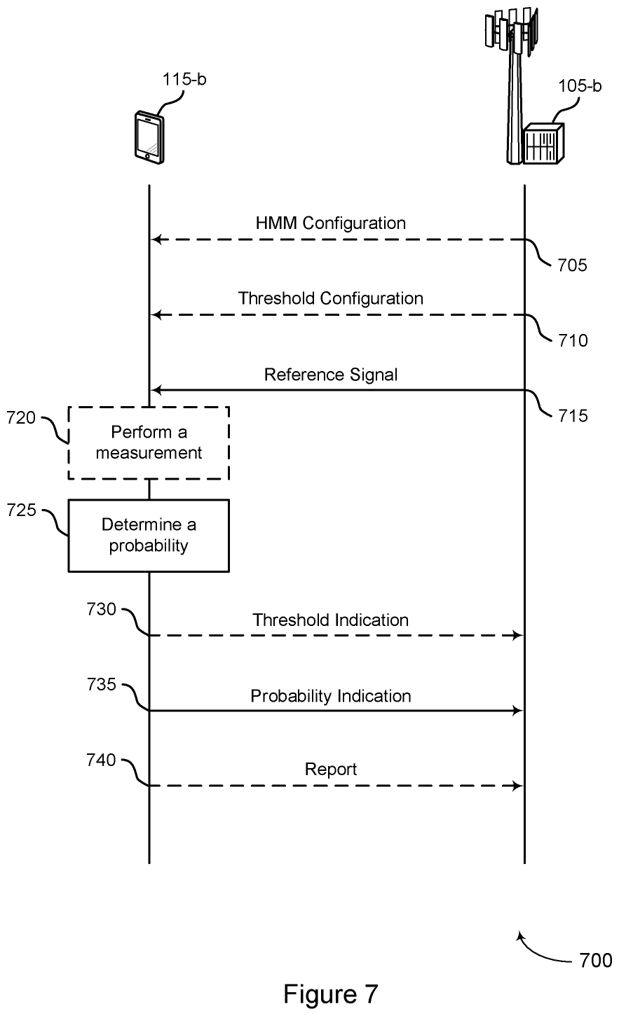

FIG. 7 illustrates an example of a process flow 700 that supports signaling enhancement for beam change predictions via modeling in accordance with aspects of the present disclosure. The process flow 700 may implement aspects of the wireless communications system 100 and the wireless communications system 200. For example, the process flow 700 may be implemented by a base station 105-b or a UE 115-b, which may be examples of the corresponding devices described with reference to FIGS. 1 and 2. In some examples, the base station 105-b and the UE 115-b may implement the process flow 700 to promote network efficiencies by supporting beam change predictions via an HMM, as described in the present disclosure. The process flow 700 may also be implemented by the base station 105-b and the UE 115-b to promote high reliability and low latency operations, among other benefits. In the following description of the process flow 700, the operations between the UE 115-b and the base station 105-b may be transmitted in a different order than the example order shown, or the operations performed by the UE 115-b and the base station 105-b may be performed in different orders or at different times. Some operations may also be omitted.

A communication device (for example, the UE 115-b) may use a machine learning model, such as an HMM, an LSTM neural network, a GRU neural network, a CNN, an RNN, or a DNN, to predict whether a top beam change will occur (for example, a rigid decision) or a probability that a top bam change will occur (for example, a soft decision). In some examples, the UE 115-b may use the HMM. In such examples, the top beam change prediction (or the probability of a top beam change occurring) may be based on an HMM configuration and results measured over a beam measurement cycle. For example, at 705 the UE 115-b may receive an indication of an HMM configuration from a network node (for example, the base station 105-b). In some examples, the HMM configuration may be an HMM configuration described in the present disclosure, including with reference to FIG. 3. For example, the HMM configuration may include a set of transition probabilities associated with a set of beams and a set of emission probabilities associated with the set of beams. Each transition probability of the set may correspond to a transition of a beam (for example, of the set of beams) from a first status to a second status and each emission probability of the set may correspond to an observed status of a beam (for example, of the set of beams). The transmission probabilities and the emission probabilities may be examples of the respective probabilities described with reference to FIG. 3.

In some examples, at 710, the UE 115-b may receive a threshold configuration. The threshold configuration may indicate one or multiple thresholds, which may each be an example of a threshold described in the present disclosure, including with reference to FIGS. 5A and 5B. At 715, the UE 115-b may receive a reference signal (for example an SSB or a CSI-RS) associated with a beam of the set of beams. In some examples, the UE 115-b may perform one or more measurements on the reference signal received at 715. For example, at 720, the UE 115-b may perform a measurement (for example, an RSRP measurement or an SINR measurement) on the beam over a beam measurement cycle. The beam measurement cycle may be an example of a first beam measurement cycle described in the present disclosure including with reference to FIGS. 3, 4, 5A, and 5B. The UE 115-b may perform the beam measurement based on the indication of the HMM configuration.

At 725, the UE 115-b may determine a probability associated with the adjustment of the beam (for example, whether the top beam change will occur). That is, the UE 115-b may determine a probability associated with an adjustment of the beam. For example, the probability may indicate whether the beam will change over a duration from a first beam associated with a first beam index to a second beam associated with a second beam index based on the reference signal (for example, received by the UE 115-b at 715). In some examples, the probability may be determined by the UE 115-b based on the machine learning model and performing one or more measurements on the beam. For example, if the UE 115-b uses the HMM, the probability may be based on the HMM configuration and performing the measurement on the beam at 720. In some examples, the UE 115-b may determine whether the probability satisfies a threshold of the one or multiple thresholds indicated by the threshold configuration received from the base station 105-b at 710. In some examples, at 730, the UE 115-b may transmit an indication of the threshold (for example, a threshold indication) to the base station 105-b.

At 735, the UE 115-b may transmit an indication of the probability associated with the adjustment of the beam to the base station 105-b (for example, a network node). In some examples, transmitting the indication of the probability may include transmitting a status indication associated with whether an adjustment of the beam to the base station 105-b. The status indication may be based on the HMM configuration and performing the measurement on the beam at 720. In some examples, the UE 115-b may transmit the status indication based on the probability satisfying the threshold. In some examples, at 740, the UE 115-b may transmit a report to the base station 105-b. The report may include the status indication and an indication of the threshold.

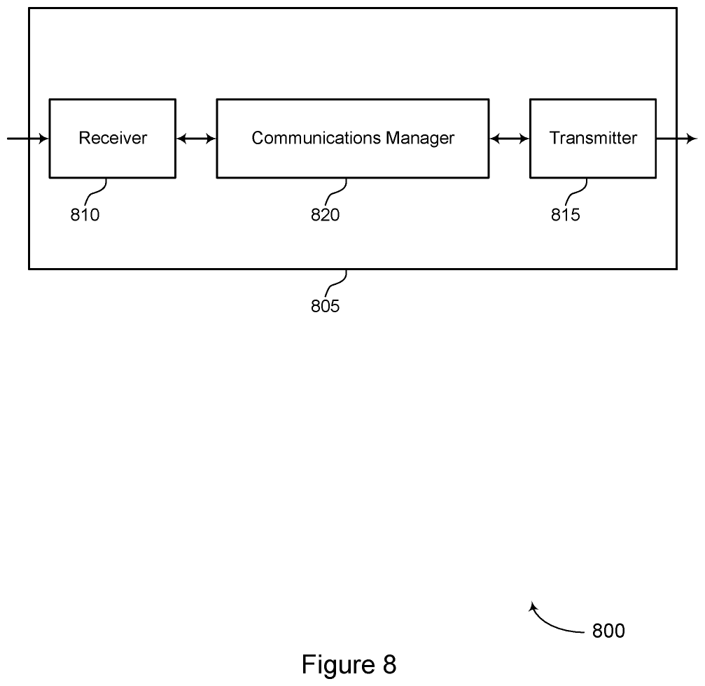

FIG. 8 shows a block diagram 800 of a device 805 that supports signaling enhancement for beam change predictions via modeling in accordance with one or more aspects of the present disclosure. The device 805 may be an example of aspects of a UE 115 as described in the present disclosure. The device 805 may include a receiver 810, a transmitter 815, and a communications manager 820. The device 805 may also include a processor. Each of these components may be in communication with one another (for example, via one or more buses).

The receiver 810 may provide a means for receiving information such as packets, user data, control information, or any combination thereof associated with various information channels (for example, control channels, data channels, information channels related to signaling enhancement for beam change predictions via modeling). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (for example, control channels, data channels, information channels related to signaling enhancement for beam change predictions via modeling). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of signaling enhancement for beam change predictions via modeling as described in the present disclosure. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (for example, in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally, or alternatively, in some examples, the communications manager 820, the receiver 810, the transmitter 815, or various combinations or components thereof may be implemented in code (for example, as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (for example, configured as or otherwise supporting a means for performing the functions described in the present disclosure).

In some examples, the communications manager 820 may be configured to perform various operations (for example, receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described in the present disclosure.

The communications manager 820 may support wireless communication at a UE (for example, the device 805) in accordance with examples as disclosed herein. For example, the communications manager 820 may be configured as or otherwise support a means for receiving, from a network node, a reference signal associated with a beam of a set of beams used for wireless communications at the UE, each beam of the set of beams being associated with a respective beam index. The communications manager 820 may be configured as or otherwise support a means for determining a probability associated with an adjustment of the beam, the probability indicating whether the beam will change over a duration from a first beam associated with a first beam index to a second beam associated with a second beam index based on the reference signal. The communications manager 820 may be configured as or otherwise support a means for transmitting, to the network node, an indication of the probability associated with the adjustment of the beam.

By including or configuring the communications manager 820 in accordance with examples as described in the present disclosure, the device 805 (for example, a processor controlling or otherwise coupled with the receiver 810, the transmitter 815, the communications manager 820, or a combination thereof) may support techniques for beam change predictions. For example, the device 805 may predict beam changes via a machine learning model at a UE 115, which may result in reduced power consumption and more efficient utilization of communication resources.

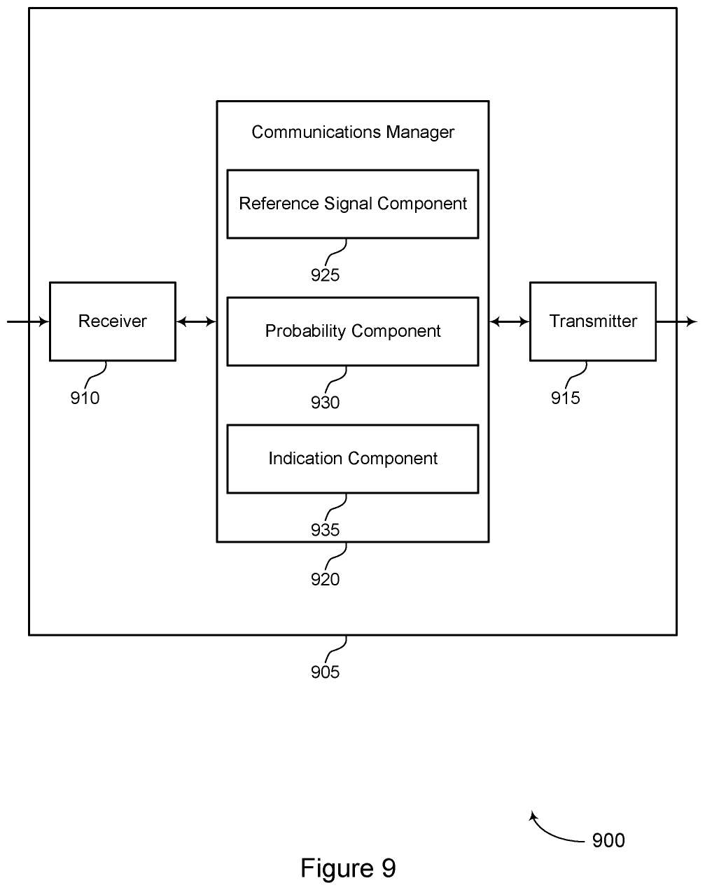

FIG. 9 shows a block diagram 900 of a device 905 that supports signaling enhancement for beam change predictions via modeling in accordance with one or more aspects of the present disclosure. The device 905 may be an example of aspects of a device 805 or a UE 115 as described in the present disclosure. The device 905 may include a receiver 910, a transmitter 915, and a communications manager 920. The device 905 may also include a processor. Each of these components may be in communication with one another (for example, via one or more buses).

The receiver 910 may provide a means for receiving information such as packets, user data, control information, or any combination thereof associated with various information channels (for example, control channels, data channels, information channels related to signaling enhancement for beam change predictions via modeling). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (for example, control channels, data channels, information channels related to signaling enhancement for beam change predictions via modeling). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of signaling enhancement for beam change predictions via modeling as described in the present disclosure. For example, the communications manager 920 may include a reference signal component 925, a probability component 930, an indication component 935, or any combination thereof. The communications manager 920 may be an example of aspects of a communications manager 820 as described in the present disclosure. In some examples, the communications manager 920, or various components thereof, may be configured to perform various operations (for example, receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described in the present disclosure.

The communications manager 920 may support wireless communication at a UE (for example, the device 905) in accordance with examples as disclosed herein. The reference signal component 925 may be configured as or otherwise support a means for receiving, from a network node, a reference signal associated with a beam of a set of beams used for wireless communications at the UE, each beam of the set of beams being associated with a respective beam index. The probability component 930 may be configured as or otherwise support a means for determining a probability associated with an adjustment of the beam, the probability indicating whether the beam will change over a duration from a first beam associated with a first beam index to a second beam associated with a second beam index based on the reference signal. The indication component 935 may be configured as or otherwise support a means for transmitting, to the network node, an indication of the probability associated with the adjustment of the beam.

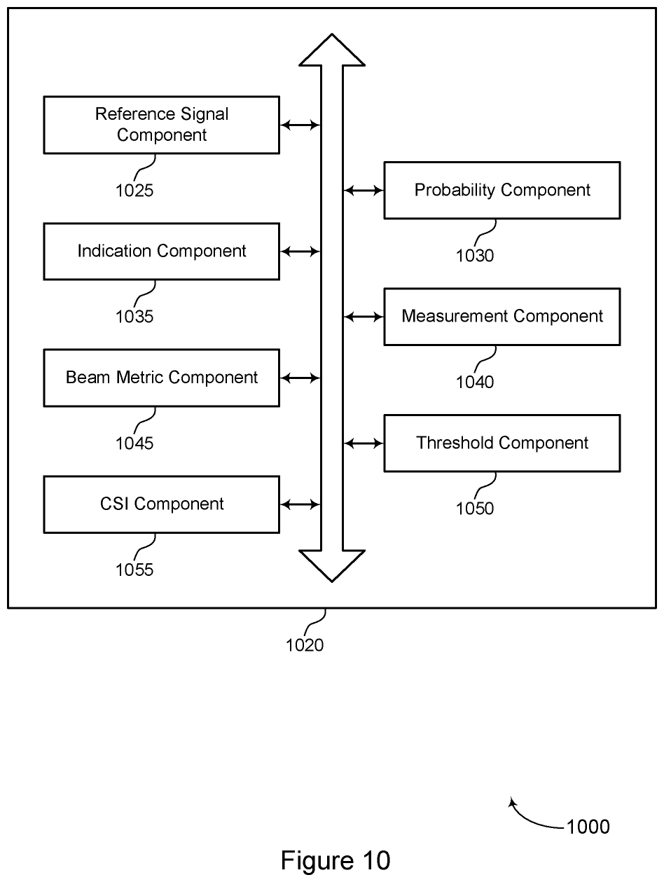

FIG. 10 shows a block diagram 1000 of a communications manager 1020 that supports signaling enhancement for beam change predictions via modeling in accordance with one or more aspects of the present disclosure. The communications manager 1020 may be an example of aspects of a communications manager 820, a communications manager 920, or both, as described in the present disclosure. The communications manager 1020, or various components thereof, may be an example of means for performing various aspects of signaling enhancement for beam change predictions via modeling as described in the present disclosure. For example, the communications manager 1020 may include a reference signal component 1025, a probability component 1030, an indication component 1035, a measurement component 1040, a beam metric component 1045, a threshold component 1050, a CSI component 1055, or any combination thereof. Each of these components may communicate, directly or indirectly, with one another (for example, via one or more buses).

The communications manager 1020 may support wireless communication at a UE in accordance with examples as disclosed herein. The reference signal component 1025 may be configured as or otherwise support a means for receiving, from a network node, a reference signal associated with a beam of a set of beams used for wireless communications at the UE, each beam of the set of beams being associated with a respective beam index. The probability component 1030 may be configured as or otherwise support a means for determining a probability associated with an adjustment of the beam, the probability indicating whether the beam will change over a duration from a first beam associated with a first beam index to a second beam associated with a second beam index based on the reference signal. The indication component 1035 may be configured as or otherwise support a means for transmitting, to the network node, an indication of the probability associated with the adjustment of the beam.

In some examples, to support transmitting an indication of the probability, the indication component 1035 may be configured as or otherwise support a means for transmitting, to the network node, a status indication associated with whether the adjustment of the beam will occur, where transmitting the status indication is based on the probability. In some examples, the threshold component 1050 may be configured as or otherwise support a means for receiving, from the network node, an indication of a threshold. In some examples, the probability component 1030 may be configured as or otherwise support a means for determining whether the probability satisfies the threshold, where transmitting the status indication is based on the probability satisfying the threshold.

In some examples, the threshold component 1050 may be configured as or otherwise support a means for transmitting, to the network node, an indication of a threshold. In some examples, the probability component 1030 may be configured as or otherwise support a means for determining whether the probability satisfies the threshold, where transmitting the status indication is based on the probability satisfying the threshold. In some examples, the probability component 1030 may be configured as or otherwise support a means for determining whether the probability satisfies a threshold, where transmitting the status indication includes. In some examples, the indication component 1035 may be configured as or otherwise support a means for transmitting, to the network node, a report including the status indication and an indication of the threshold.

In some examples, the threshold component 1050 may be configured as or otherwise support a means for receiving, from the network node, an indication of a set of thresholds. In some examples, the threshold component 1050 may be configured as or otherwise support a means for selecting a threshold of the set of thresholds based on a performance metric associated with performing a measurement on the beam. In some examples, the probability component 1030 may be configured as or otherwise support a means for determining whether the probability satisfies the threshold, where transmitting the status indication is based on the probability satisfying the threshold.

In some examples, determining the probability is based on a machine learning model. In some examples, the machine learning model includes one or more of a long short-term memory neural network, a gated recurrent unit neural network, a convolution neural network, a recurrent neural network, or a deep neural network.

In some examples, the probability component 1030 may be configured as or otherwise support a means for determining the probability is based on receiving the indication. In some examples, the probability component 1030 may be configured as or otherwise support a means for determining the probability is based on determining the machine learning model. In some examples, the machine learning model includes a hidden Markov Model.

In some examples, the probability component 1030 may be configured as or otherwise support a means for determining the probability is based on receiving the indication of the hidden Markov model configuration. In some examples, transmitting the indication of the probability includes transmitting, to the network node, a report including the indication of the probability.

In some examples, to support transmitting the report including the indication of the probability, the CSI component 1055 may be configured as or otherwise support a means for transmit a first channel state information report that indicates one or more measured channel characteristics of a channel used for the wireless communications between the UE and the network node. In some examples, to support transmitting the report including the indication of the probability, the CSI component 1055 may be configured as or otherwise support a means for transmit a second channel state information report that indicates the probability.

In some examples, the measurement component 1040 may be configured as or otherwise support a means for performing a measurement on the beam over a beam measurement cycle. In some examples, the beam metric component 1045 may be configured as or otherwise support a means for determining a beam metric value based on performing the measurement on the beam, where the probability is based on the beam metric value and a beam index associated with the beam. In some examples, the beam index associated with the beam includes the first beam index or the second beam index.

In some examples, the indication component 1035 may be configured as or otherwise support a means for transmitting the indication of the probability is based on determining one or both of whether the beam metric value changed relative to the second beam metric value associated with the second beam measurement cycle or whether the beam index changed relative to the second beam index associated with the second beam measurement cycle. In some examples, the indication is received via an RRC message, a downlink control information, or a MAC-CE. In some examples, the indication is based on one or both of a position of the UE or a trajectory of the UE.

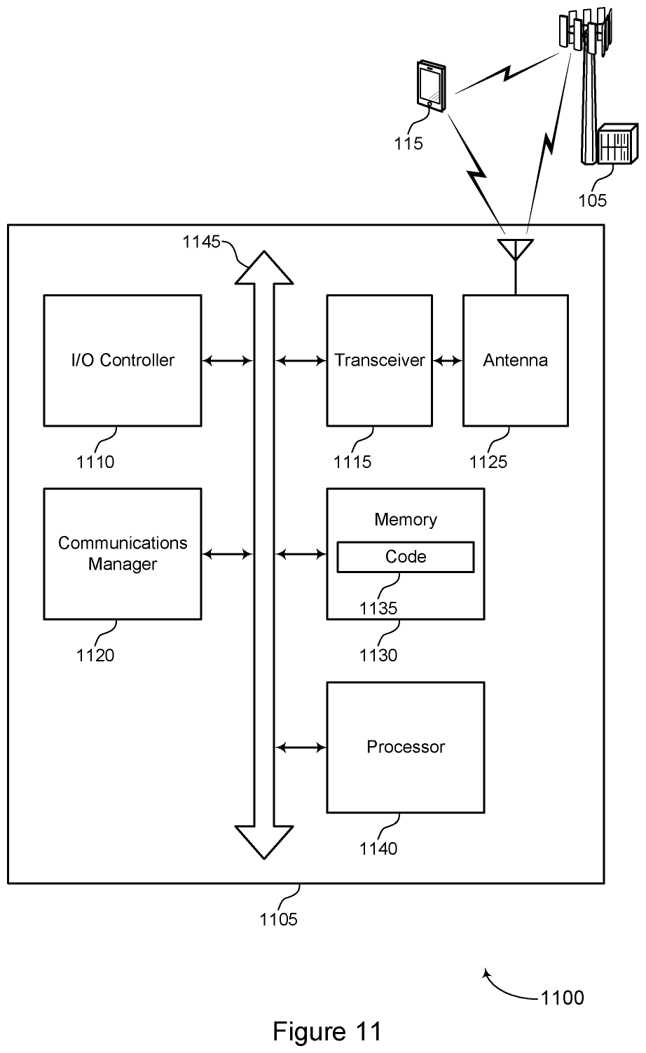

FIG. 11 shows a diagram of a system 1100 including a device 1105 that supports signaling enhancement for beam change predictions via modeling in accordance with one or more aspects of the present disclosure. The device 1105 may be an example of or include the components of a device 805, a device 905, or a UE 115 as described in the present disclosure. The device 1105 may communicate (for example, wirelessly) with one or more base stations 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (for example, operatively, communicatively, functionally, electronically, electrically) via one or more buses (for example, a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described in the present disclosure. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described in the present disclosure.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (for example, when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (for example, the memory 1130) to cause the device 1105 to perform various functions (for example, functions or tasks supporting signaling enhancement for beam change predictions via modeling). For example, the device 1105 or a component of the device 1105 may include a processor 1140 and memory 1130 coupled to the processor 1140, the processor 1140 and memory 1130 configured to perform various functions described herein.

The communications manager 1120 may support wireless communication at a UE (for example, the device 1105) in accordance with examples as disclosed herein. For example, the communications manager 1120 may be configured as or otherwise support a means for receiving, from a network node, a reference signal associated with a beam of a set of beams used for wireless communications at the UE, each beam of the set of beams being associated with a respective beam index. The communications manager 1120 may be configured as or otherwise support a means for determining a probability associated with an adjustment of the beam, the probability indicating whether the beam will change over a duration from a first beam associated with a first beam index to a second beam associated with a second beam index based on the reference signal. The communications manager 1120 may be configured as or otherwise support a means for transmitting, to the network node, an indication of the probability associated with the adjustment of the beam.

By including or configuring the communications manager 1120 in accordance with examples as described in the present disclosure, the device 1105 may support techniques for beam change predictions. For example, the device 1105 may predict beam changes via a machine learning model at a UE 115, which may result in communication reliability, reduced power consumption, more efficient utilization of communication resources, and longer battery life.

In some examples, the communications manager 1120 may be configured to perform various operations (for example, receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of signaling enhancement for beam change predictions via modeling as described in the present disclosure, or the processor 1140 and the memory 1130 may be otherwise configured to perform or support such operations.

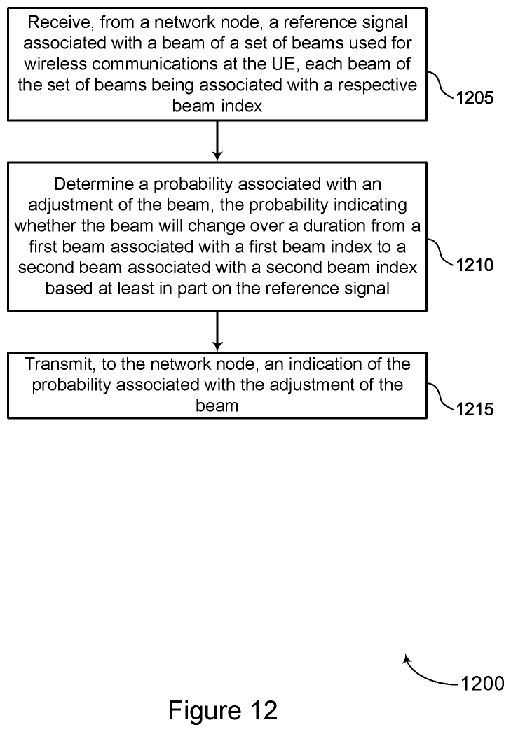

FIG. 12 shows a flowchart illustrating a method 1200 that supports signaling enhancement for beam change predictions via modeling in accordance with one or more aspects of the present disclosure. The operations of the method 1200 may be implemented by a UE or its components as described in the present disclosure. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving, from a network node, a reference signal associated with a beam of a set of beams used for wireless communications at the UE, each beam of the set of beams being associated with a respective beam index. The operations of 1205 may be performed in accordance with examples as disclosed herein. In some examples, aspects of the operations of 1205 may be performed by a reference signal component 1025 as described with reference to FIG. 10.

At 1210, the method may include determining a probability associated with an adjustment of the beam, the probability indicating whether the beam will change over a duration from a first beam associated with a first beam index to a second beam associated with a second beam index based on the reference signal. The operations of 1210 may be performed in accordance with examples as disclosed herein. In some examples, aspects of the operations of 1210 may be performed by a probability component 1030 as described with reference to FIG. 10.

At 1215, the method may include transmitting, to the network node, an indication of the probability associated with the adjustment of the beam. The operations of 1215 may be performed in accordance with examples as disclosed herein. In some examples, aspects of the operations of 1215 may be performed by an indication component 1035 as described with reference to FIG. 10.

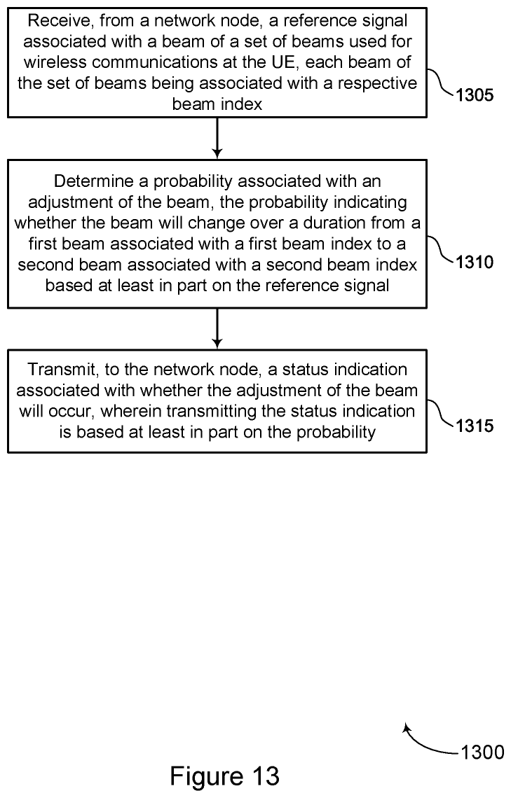

FIG. 13 shows a flowchart illustrating a method 1300 that supports signaling enhancement for beam change predictions via modeling in accordance with one or more aspects of the present disclosure. The operations of the method 1300 may be implemented by a UE or its components as described in the present disclosure. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving, from a network node, a reference signal associated with a beam of a set of beams used for wireless communications at the UE, each beam of the set of beams being associated with a respective beam index. The operations of 1305 may be performed in accordance with examples as disclosed herein. In some examples, aspects of the operations of 1305 may be performed by a reference signal component 1025 as described with reference to FIG. 10.

At 1310, the method may include determining a probability associated with an adjustment of the beam, the probability indicating whether the beam will change over a duration from a first beam associated with a first beam index to a second beam associated with a second beam index based on the reference signal. The operations of 1310 may be performed in accordance with examples as disclosed herein. In some examples, aspects of the operations of 1310 may be performed by a probability component 1030 as described with reference to FIG. 10.

At 1315, the method may include transmitting, to the network node, a status indication associated with whether the adjustment of the beam will occur, where transmitting the status indication is based on the probability. The operations of 1315 may be performed in accordance with examples as disclosed herein. In some examples, aspects of the operations of 1315 may be performed by an indication component 1035 as described with reference to FIG. 10.

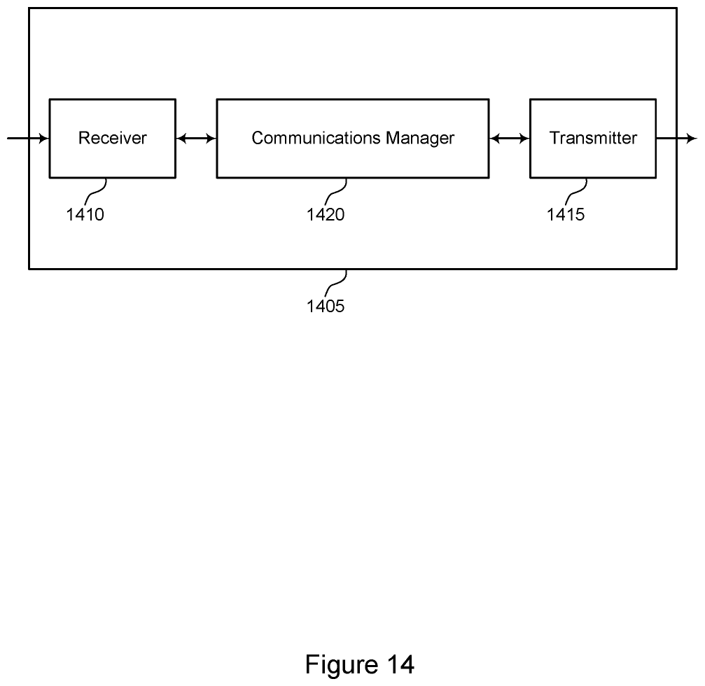

FIG. 14 shows a block diagram of a device 1405 that supports signaling enhancement for beam change predictions via modeling in accordance with aspects of the present disclosure. The device 1405 may be an example of aspects of a UE 115 as described in the present disclosure. The device 1405 may include a receiver 1410, a transmitter 1415, and a communications manager 1420. The communications manager 1420 can be implemented, at least in part, by one or both of a modem and a processor. Each of these components may be in communication with one another (for example, via one or more buses).

The receiver 1410 may provide a means for receiving information such as packets, user data, control information, or any combination thereof associated with various information channels (for example, control channels, data channels, information channels related to signaling enhancement for beam change predictions via modeling). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (for example, control channels, data channels, information channels related to signaling enhancement for beam change predictions via modeling). In some examples, the transmitter 1415 may be co-located with a receiver 1410 in a transceiver component. The transmitter 1415 may utilize a single antenna or a set of multiple antennas.

The communications manager 1420, the receiver 1410, the transmitter 1415, or various combinations thereof or various components thereof may be examples of means for performing various aspects of signaling enhancement for beam change predictions via modeling as described in the present disclosure. For example, the communications manager 1420, the receiver 1410, the transmitter 1415, or various combinations or components thereof may support a method for performing one or more of the functions described herein.

In some examples, the communications manager 1420 may be configured to perform various operations (for example, receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described in the present disclosure.

The communications manager 1420 may support wireless communication at a UE (for example, the device 1405) in accordance with examples as disclosed herein. For example, the communications manager 1420 may be configured as or otherwise support a means for receiving, from a base station, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams. The communications manager 1420 may be configured as or otherwise support a means for receiving, from the base station, a reference signal associated with a beam of the set of beams. The communications manager 1420 may be configured as or otherwise support a means for performing a measurement on the beam over a beam measurement cycle based on the indication of the HMM configuration. The communications manager 1420 may be configured as or otherwise support a means for transmitting, to the base station, a status indication associated with whether an adjustment of the beam will occur, the status indication based on the HMM configuration and performing the measurement on the beam.

By including or configuring the communications manager 1420 in accordance with examples as described in the present disclosure, the device 1405 (for example, a processor controlling or otherwise coupled with the receiver 1410, the transmitter 1415, the communications manager 1420, or a combination thereof) may support techniques for beam change predictions. For example, the device 1405 may predict beam changes via an HMM at a UE 115, which may result in reduced power consumption and more efficient utilization of communication resources.

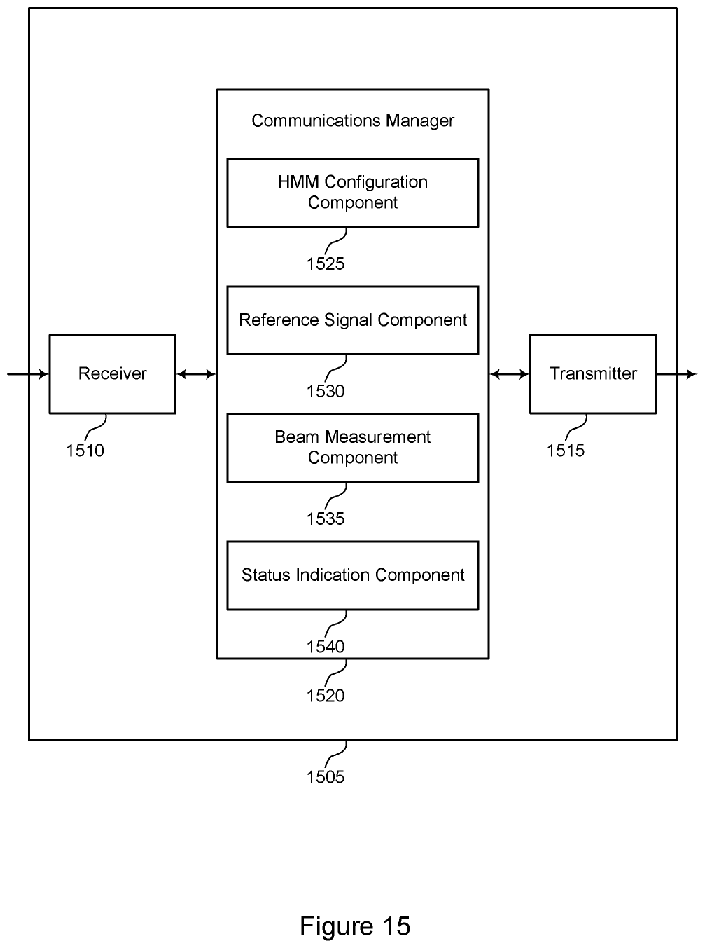

FIG. 15 shows a block diagram of a device 1505 that supports signaling enhancement for beam change predictions via modeling in accordance with aspects of the present disclosure. The device 1505 may be an example of aspects of a device 1405 or a UE 115 as described in the present disclosure. The device 1505 may include a receiver 1510, a transmitter 1515, and a communications manager 1520. The communications manager 1520 can be implemented, at least in part, by one or both of a modem and a processor. Each of these components may be in communication with one another (for example, via one or more buses).

The receiver 1510 may provide a means for receiving information such as packets, user data, control information, or any combination thereof associated with various information channels (for example, control channels, data channels, information channels related to signaling enhancement for beam change predictions via modeling). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (for example, control channels, data channels, information channels related to signaling enhancement for beam change predictions via modeling). In some examples, the transmitter 1515 may be co-located with a receiver 1510 in a transceiver component. The transmitter 1515 may utilize a single antenna or a set of multiple antennas.

The device 1505, or various components thereof, may be an example of means for performing various aspects of signaling enhancement for beam change predictions via modeling as described in the present disclosure. For example, the communications manager 1520 may include an HMM configuration component 1525, a reference signal component 1530, a beam measurement component 1535, a status indication component 1540, or any combination thereof. The communications manager 1520 may be an example of aspects of a communications manager 1420 as described in the present disclosure. In some examples, the communications manager 1520, or various components thereof, may be configured to perform various operations (for example, receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described in the present disclosure.

The communications manager 1520 may support wireless communication at a UE (for example, the device 1505) in accordance with examples as disclosed in the present disclosure. The HMM configuration component 1525 may be configured as or otherwise support a means for receiving, from a base station, an indication of a HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams. The reference signal component 1530 may be configured as or otherwise support a means for receiving, from the base station, a reference signal associated with a beam of the set of beams. The beam measurement component 1535 may be configured as or otherwise support a means for performing a measurement on the beam over a beam measurement cycle based on the indication of the HMM configuration. The status indication component 1540 may be configured as or otherwise support a means for transmitting, to the base station, a status indication associated with whether an adjustment of the beam will occur, the status indication based on the HMM configuration and performing the measurement on the beam.

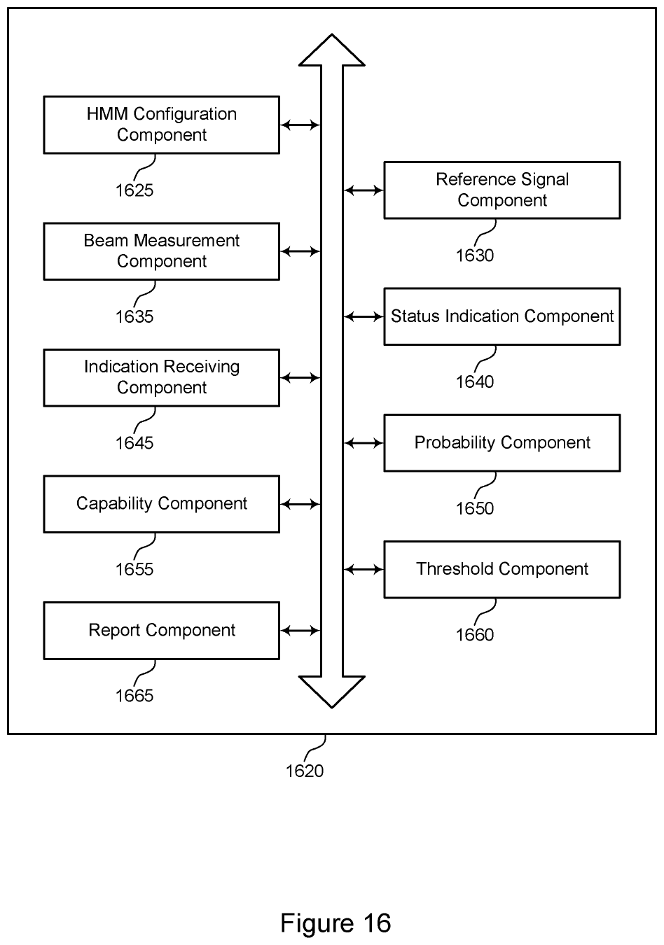

FIG. 16 shows a block diagram of a communications manager 1620 that supports signaling enhancement for beam change predictions via modeling in accordance with aspects of the present disclosure. The communications manager 1620 may be an example of aspects of a communications manager 1420, a communications manager 1520, or both, as described in the present disclosure. The communications manager 1620, or various components thereof, may be an example of means for performing various aspects of signaling enhancement for beam change predictions via modeling as described in the present disclosure. For example, the communications manager 1620 may include an HMM configuration component 1625, a reference signal component 1630, a beam measurement component 1635, a status indication component 1640, an indication receiving component 1645, a probability component 1650, a capability component 1655, a threshold component 1660, a report component 1665, or any combination thereof. Each of these components may communicate, directly or indirectly, with one another (for example, via one or more buses).

The communications manager 1620 may support wireless communication at a UE 115 in accordance with examples as disclosed in the present disclosure. The HMM configuration component 1625 may be configured as or otherwise support a means for receiving, from a base station, an indication of a HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams. The reference signal component 1630 may be configured as or otherwise support a means for receiving, from the base station, a reference signal associated with a beam of the set of beams. The beam measurement component 1635 may be configured as or otherwise support a means for performing a measurement on the beam over a beam measurement cycle based on the indication of the HMM configuration. The status indication component 1640 may be configured as or otherwise support a means for transmitting, to the base station, a status indication associated with whether an adjustment of the beam will occur, the status indication based on the HMM configuration and performing the measurement on the beam.

In some examples, the set of transition probabilities and the set of emission probabilities of the HMM configuration are associated with whether a beam metric changed from a second beam measurement cycle to the beam measurement cycle, the beam metric based on performing the measurement on the beam. In some examples, the beam measurement component 1635 may be configured as or otherwise support a means for determining a beam metric value based on performing the measurement on the beam. In some examples, the status indication is based on the beam metric value and a beam index associated with the beam.

In some examples, the beam measurement component 1635 may be configured as or otherwise support a means for determining one or both of whether the beam metric value changed relative to a second beam metric value associated with a second beam measurement cycle or whether the beam index changed relative to a second beam index associated with the second beam measurement cycle. In some examples, transmitting the status indication is based on the determination.

In some examples, the indication receiving component 1645 may be configured as or otherwise support a means for receiving, from the base station, an indication including one or more of an indication to change the beam measurement cycle, an indication to change a transition probability of the set of transition probabilities, an indication to change an emission probability of the set of emission probabilities, or an indication of a set of reference signals to be measured. In some examples, the indication is received via an RRC message, a DCI, or a MAC-CE. In some examples, the indication is based on one or both of a position of the UE or a trajectory of the UE.

In some examples, the status indication component 1640 may be configured as or otherwise support a means for transmitting, to the base station, a request based on the status indication, the request including one or more of a request to decrease a report periodicity, a request to trigger one or more reports, a request to change a number of resources associated with a report, a predicted change in the beam, or a predicted change from the beam to a second beam different from the beam. In some examples, the probability component 1650 may be configured as or otherwise support a means for determining, based on the HMM configuration and performing the measurement on the beam, a probability associated with the adjustment of the beam. In some examples, transmitting the status indication is based on the probability.

In some examples, the threshold component 1660 may be configured as or otherwise support a means for receiving, from the base station, an indication of a threshold. In some examples, the threshold component 1660 may be configured as or otherwise support a means for determining whether the probability satisfies the threshold, where transmitting the status indication is based on the probability satisfying the threshold.

In some examples, the threshold component 1660 may be configured as or otherwise support a means for transmitting, to the base station, an indication of a threshold. In some examples, receiving the HMM configuration is based on transmitting the indication of the threshold. In some examples, the threshold component 1660 may be configured as or otherwise support a means for determining whether the probability satisfies the threshold. In some examples, transmitting the status indication is based on the probability satisfying the threshold.

In some examples, the threshold component 1660 may be configured as or otherwise support a means for determining whether the probability satisfies a threshold. In some examples, transmitting the status indication includes. In some examples, the report component 1665 may be configured as or otherwise support a means for transmitting, to the base station, a report including the status indication and an indication of the threshold.

In some examples, the threshold component 1660 may be configured as or otherwise support a means for receiving, from the base station, an indication of a set of thresholds. In some examples, the threshold component 1660 may be configured as or otherwise support a means for selecting a threshold of the set of thresholds based on a performance metric associated with performing the measurement. In some examples, the threshold component 1660 may be configured as or otherwise support a means for determining whether the probability satisfies the selected threshold, where transmitting the status indication is based on the selected probability satisfying the threshold. In some examples, the report component 1665 may be configured as or otherwise support a means for transmitting, to the base station, a report including the status indication and an indication of the selected threshold.

In some examples, the capability component 1655 may be configured as or otherwise support a means for transmitting, to the base station, an indication of a capability of the UE to determine a probability associated with the adjustment of the beam based on an HMM corresponding to the HMM configuration. In some examples, the status indication indicates whether the beam will change from a first beam associated with a first beam index to a second beam associated with a second beam index over a duration.

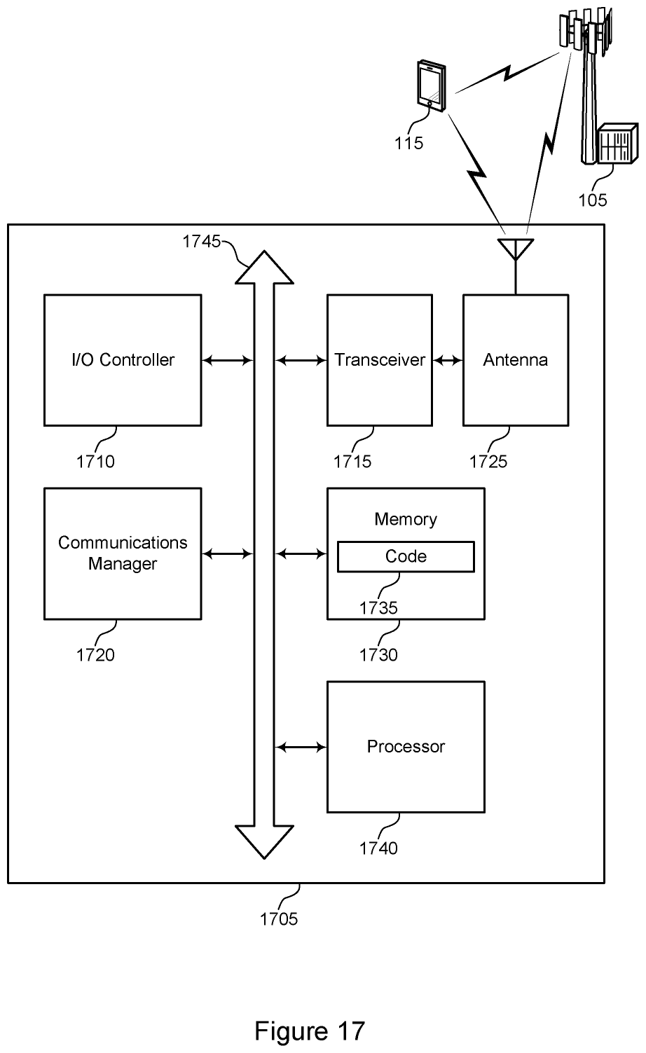

FIG. 17 shows a diagram of a system including a device 1705 that supports signaling enhancement for beam change predictions via modeling in accordance with aspects of the present disclosure. The device 1705 may be an example of or include the components of a device 1405, a device 1505, or a UE 115 as described in the present disclosure. The device 1705 may communicate wirelessly with one or more base stations 105, UEs 115, or any combination thereof. The device 1705 may include components for bi-directional voice and data communications including components for transmitting and receiving communications, such as a communications manager 1720, an input/output (I/O) controller 1710, a transceiver 1715, an antenna 1725, a memory 1730, code 1735, and a processor 1740. These components may be in electronic communication or otherwise coupled (for example, operatively, communicatively, functionally, electronically, electrically) via one or more buses (for example, a bus 1745).

The I/O controller 1710 may manage input and output signals for the device 1705. The I/O controller 1710 may also manage peripherals not integrated into the device 1705. In some examples, the I/O controller 1710 may represent a physical connection or port to an external peripheral. In some examples, the I/O controller 1710 may utilize an operating system such as iOS®, ANDROID®, MS-DOS®, MS-WINDOWS®, OS/2®, UNIX®, LINUX®, or another known operating system. Additionally or alternatively, the I/O controller 1710 may represent or interact with a modem, a keyboard, a mouse, a touchscreen, or a similar device. In some examples, the I/O controller 1710 may be implemented as part of a processor, such as the processor 1740. In some examples, a user may interact with the device 1705 via the I/O controller 1710 or via hardware components controlled by the I/O controller 1710.

In some examples, the device 1705 may include a single antenna 1725. However, in some other cases, the device 1705 may have more than one antenna 1725, which may be capable of concurrently transmitting or receiving multiple wireless transmissions. The transceiver 1715 may communicate bi-directionally, via the one or more antennas 1725, wired, or wireless links as described in the present disclosure. For example, the transceiver 1715 may represent a wireless transceiver and may communicate bi-directionally with another wireless transceiver. The transceiver 1715 may also include a modem to modulate the packets, to provide the modulated packets to one or more antennas 1725 for transmission, and to demodulate packets received from the one or more antennas 1725. The transceiver 1715, or the transceiver 1715 and one or more antennas 1725, may be an example of a transmitter 1415, a transmitter 1515, a receiver 1410, a receiver 1510, or any combination thereof or component thereof, as described in the present disclosure.

The memory 1730 may include random access memory (RAM) and read-only memory (ROM). The memory 1730 may store computer-readable, computer-executable code 1735 including instructions that, in examples in which the instructions are executed by the processor 1740, cause the device 1705 to perform various functions described in the present disclosure. The code 1735 may be stored in a non-transitory computer-readable medium such as system memory or another type of memory. In some examples, the code 1735 may not be directly executable by the processor 1740 but may cause a computer (for example, in which the code is compiled and executed) to perform functions described in the present disclosure. In some examples, the memory 1730 may contain, among other things, a basic I/O system (BIOS) which may control basic hardware or software operation such as the interaction with peripheral components or devices.

The processor 1740 may include an intelligent hardware device (for example, a general-purpose processor, a DSP, a CPU, a microcontroller, an ASIC, a field programmable gate array (FPGA), a programmable logic device, a discrete gate or transistor logic component, a discrete hardware component, or any combination thereof). In some examples, the processor 1740 may be configured to operate a memory array using a memory controller. In some other cases, a memory controller may be integrated into the processor 1740. The processor 1740 may be configured to execute computer-readable instructions stored in a memory (for example, the memory 1730) to cause the device 1705 to perform various functions (for example, functions or tasks supporting signaling enhancement for beam change predictions via modeling). For example, the device 1705 or a component of the device 1705 may include a processor 1740 and memory 1730 coupled with the processor 1740, the processor 1740 and memory 1730 configured to perform various functions described in the present disclosure.

The communications manager 1720 may support wireless communication at a UE (for example, the device 1705) in accordance with examples as disclosed in the present disclosure. For example, the communications manager 1720 may be configured as or otherwise support a means for receiving, from a base station, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams. The communications manager 1720 may be configured as or otherwise support a means for receiving, from the base station, a reference signal associated with a beam of the set of beams.

The communications manager 1720 may be configured as or otherwise support a means for performing a measurement on the beam over a beam measurement cycle based on the indication of the HMM configuration. The communications manager 1720 may be configured as or otherwise support a means for transmitting, to the base station, a status indication associated with whether an adjustment of the beam will occur, the status indication based on the HMM configuration and performing the measurement on the beam.

By including or configuring the communications manager 1720 in accordance with examples as described in the present disclosure, the device 1705 may support techniques for beam change predictions. For example, the device 1705 may predict beam changes via an HMM at a UE 115, which may result in communication reliability, reduced power consumption, more efficient utilization of communication resources, and longer battery life.

In some examples, the communications manager 1720 may be configured to perform various operations (for example, receiving, monitoring, transmitting) using or otherwise in cooperation with the transceiver 1715, the one or more antennas 1725, or any combination thereof. Although the communications manager 1720 is illustrated as a separate component, in some examples, one or more functions described with reference to the communications manager 1720 may be supported by or performed by the processor 1740, the memory 1730, the code 1735, or any combination thereof. For example, the code 1735 may include instructions executable by the processor 1740 to cause the device 1705 to perform various aspects of signaling enhancement for beam change predictions via modeling as described in the present disclosure, or the processor 1740 and the memory 1730 may be otherwise configured to perform or support such operations.

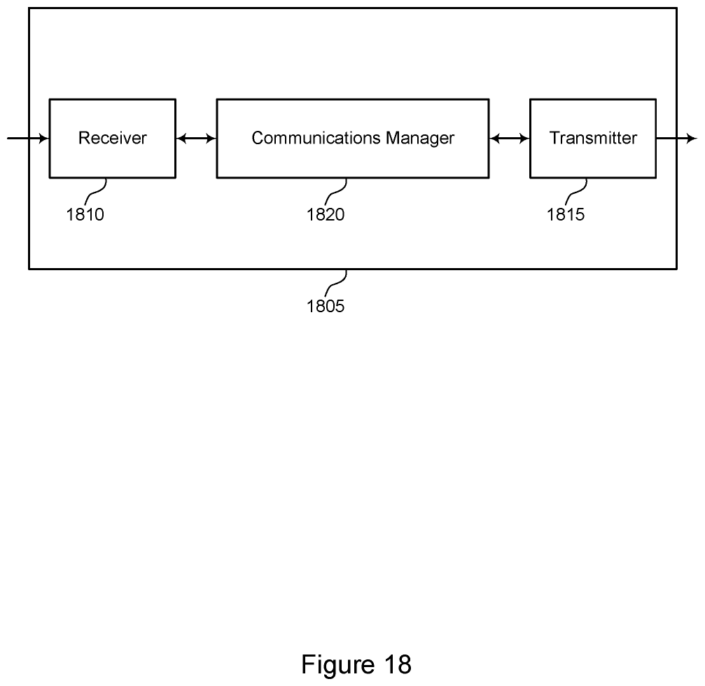

FIG. 18 shows a block diagram of a device 1805 that supports signaling enhancement for beam change predictions via modeling in accordance with aspects of the present disclosure. The device 1805 may be an example of aspects of a base station 105 as described in the present disclosure. The device 1805 may include a receiver 1810, a transmitter 1815, and a communications manager 1820. The communications manager 1820 can be implemented, at least in part, by one or both of a modem and a processor. Each of these components may be in communication with one another (for example, via one or more buses).

The receiver 1810 may provide a means for receiving information such as packets, user data, control information, or any combination thereof associated with various information channels (for example, control channels, data channels, information channels related to signaling enhancement for beam change predictions via modeling). Information may be passed on to other components of the device 1805. The receiver 1810 may utilize a single antenna or a set of multiple antennas.

The transmitter 1815 may provide a means for transmitting signals generated by other components of the device 1805. For example, the transmitter 1815 may transmit information such as packets, user data, control information, or any combination thereof associated with various information channels (for example, control channels, data channels, information channels related to signaling enhancement for beam change predictions via modeling). In some examples, the transmitter 1815 may be co-located with a receiver 1810 in a transceiver component. The transmitter 1815 may utilize a single antenna or a set of multiple antennas.

The communications manager 1820, the receiver 1810, the transmitter 1815, or various combinations thereof or various components thereof may be examples of means for performing various aspects of signaling enhancement for beam change predictions via modeling as described in the present disclosure. For example, the communications manager 1820, the receiver 1810, the transmitter 1815, or various combinations or components thereof may support a method for performing one or more of the functions described in the present disclosure.

In some examples, the communications manager 1820 may be configured to perform various operations (for example, receiving, monitoring, transmitting) using or otherwise in cooperation with the receiver 1810, the transmitter 1815, or both. For example, the communications manager 1820 may receive information from the receiver 1810, send information to the transmitter 1815, or be integrated in combination with the receiver 1810, the transmitter 1815, or both to receive information, transmit information, or perform various other operations as described in the present disclosure.

The communications manager 1820 may support wireless communication at a base station (for example, the device 1805) in accordance with examples as disclosed in the present disclosure. For example, the communications manager 1820 may be configured as or otherwise support a means for transmitting, to a UE, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams. The communications manager 1820 may be configured as or otherwise support a means for transmitting, to the UE, a reference signal associated with a beam of the set of beams. The communications manager 1820 may be configured as or otherwise support a means for receiving, from the UE, a status indication associated with whether an adjustment of the beam will occur, the status indication on the HMM configuration and the reference signal.

By including or configuring the communications manager 1820 in accordance with examples as described in the present disclosure, the device 1805 (for example, a processor controlling or otherwise coupled with the receiver 1810, the transmitter 1815, the communications manager 1820, or a combination thereof) may support techniques for beam change predictions. For example, the device 1805 may support beam change predictions via an HMM at a UE 115, which may result in reduced power consumption and more efficient utilization of communication resources.

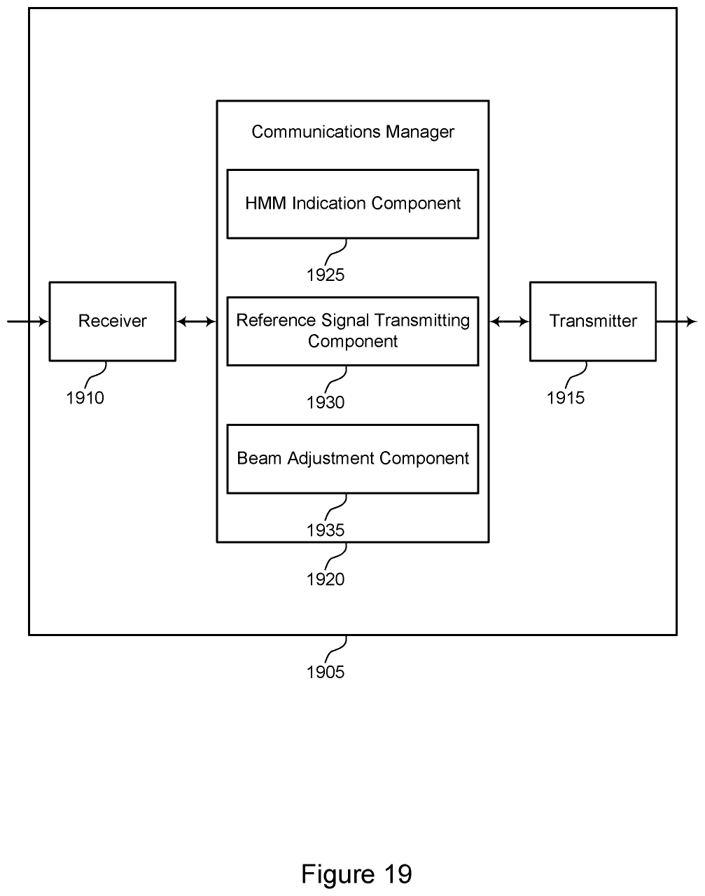

FIG. 19 shows a block diagram of a device 1905 that supports signaling enhancement for beam change predictions via modeling in accordance with aspects of the present disclosure. The device 1905 may be an example of aspects of a device 1805 or a base station 105 as described in the present disclosure. The device 1905 may include a receiver 1910, a transmitter 1915, and a communications manager 1920. The communications manager 1920 can be implemented, at least in part, by one or both of a modem and a processor. Each of these components may be in communication with one another (for example, via one or more buses).

The receiver 1910 may provide a means for receiving information such as packets, user data, control information, or any combination thereof associated with various information channels (for example, control channels, data channels, information channels related to signaling enhancement for beam change predictions via modeling). Information may be passed on to other components of the device 1905. The receiver 1910 may utilize a single antenna or a set of multiple antennas.

The transmitter 1915 may provide a means for transmitting signals generated by other components of the device 1905. For example, the transmitter 1915 may transmit information such as packets, user data, control information, or any combination thereof associated with various information channels (for example, control channels, data channels, information channels related to signaling enhancement for beam change predictions via modeling). In some examples, the transmitter 1915 may be co-located with a receiver 1910 in a transceiver component. The transmitter 1915 may utilize a single antenna or a set of multiple antennas.

The device 1905, or various components thereof, may be an example of means for performing various aspects of signaling enhancement for beam change predictions via modeling as described in the present disclosure. For example, the communications manager 1920 may include an HMM indication component 1925, a reference signal transmitting component 1930, a beam adjustment component 1935, or any combination thereof. The communications manager 1920 may be an example of aspects of a communications manager 1820 as described in the present disclosure. In some examples, the communications manager 1920, or various components thereof, may be configured to perform various operations (for example, receiving, monitoring, transmitting) using or otherwise in cooperation with the receiver 1910, the transmitter 1915, or both. For example, the communications manager 1920 may receive information from the receiver 1910, send information to the transmitter 1915, or be integrated in combination with the receiver 1910, the transmitter 1915, or both to receive information, transmit information, or perform various other operations as described in the present disclosure.

The communications manager 1920 may support wireless communication at a base station (for example, the device 1905) in accordance with examples as disclosed in the present disclosure. The HMM indication component 1925 may be configured as or otherwise support a means for transmitting, to a UE, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams. The reference signal transmitting component 1930 may be configured as or otherwise support a means for transmitting, to the UE, a reference signal associated with a beam of the set of beams. The beam adjustment component 1935 may be configured as or otherwise support a means for receiving, from the UE, a status indication associated with whether an adjustment of the beam will occur, the status indication based on the HMM configuration and the reference signal.

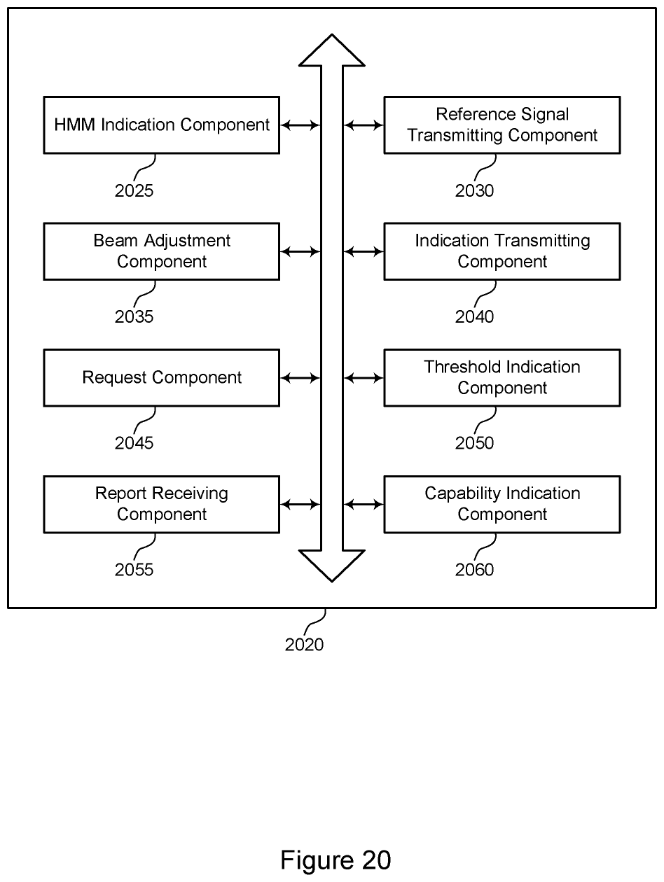

FIG. 20 shows a block diagram of a communications manager 2020 that supports signaling enhancement for beam change predictions via modeling in accordance with aspects of the present disclosure. The communications manager 2020 may be an example of aspects of a communications manager 1820, a communications manager 1920, or both, as described in the present disclosure. The communications manager 2020, or various components thereof, may be an example of means for performing various aspects of signaling enhancement for beam change predictions via modeling as described in the present disclosure. For example, the communications manager 2020 may include an HMM indication component 2025, a reference signal transmitting component 2030, a beam adjustment component 2035, an indication transmitting component 2040, a request component 2045, a threshold indication component 2050, a report receiving component 2055, a capability indication component 2060, or any combination thereof. Each of these components may communicate, directly or indirectly, with one another (for example, via one or more buses).

The communications manager 2020 may support wireless communication at a base station 105 in accordance with examples as disclosed in the present disclosure. The HMM indication component 2025 may be configured as or otherwise support a means for transmitting, to a UE, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams. The reference signal transmitting component 2030 may be configured as or otherwise support a means for transmitting, to the UE, a reference signal associated with a beam of the set of beams. The beam adjustment component 2035 may be configured as or otherwise support a means for receiving, from the UE, a status indication associated with whether an adjustment of the beam will occur, the status indication based on the HMM configuration and the reference signal. In some examples, the set of transition probabilities and the set of emission probabilities of the HMM configuration are associated with whether a beam metric changed from a second beam measurement cycle to a beam measurement cycle, the beam metric corresponding to a measurement of the beam.

In some examples, the indication transmitting component 2040 may be configured as or otherwise support a means for transmitting, to the UE, an indication including one or more of an indication to change a beam measurement cycle, an indication to change a transition probability of the set of transition probabilities, an indication to change an emission probability of the set of emission probabilities, or an indication of a set of reference signals to be measured.

In some examples, the indication is transmitted via an RRC message, a DCI, or a MAC-CE. In some examples, the indication transmitting component 2040 may be configured as or otherwise support a means for determining one or both of a position of the UE or a trajectory of the UE. In some examples, the indication is based on one or both of the position of the UE or the trajectory of the UE.

In some examples, the request component 2045 may be configured as or otherwise support a means for receiving, from the UE, a request based on the status indication, the request including one or more of a request to decrease a report periodicity, a request to trigger one or more reports, a request to change a number of resources associated with a report, a predicted change in the beam, or a predicted change from the beam to a second beam different from the beam. In some examples, the threshold indication component 2050 may be configured as or otherwise support a means for transmitting, to the UE, an indication of a threshold. In some examples, the status indication is based on a probability associated with the adjustment of the beam satisfying the threshold.

In some examples, the threshold indication component 2050 may be configured as or otherwise support a means for receiving, from the UE, an indication of a threshold. In some examples, transmitting the HMM configuration is based on receiving the indication of the threshold. In some examples, the report receiving component 2055 may be configured as or otherwise support a means for receiving, from the UE, a report including the status indication and an indication of a threshold. In some examples, the status indication is based on a probability associated with the adjustment of the beam satisfying the threshold.

In some examples, the capability indication component 2060 may be configured as or otherwise support a means for receiving, from the UE, an indication of a capability of the UE to determine a probability associated with the adjustment of the beam based on an HMM corresponding to the HMM configuration. In some examples, the status indication indicates whether the beam will change from a first beam associated with a first beam index to a second beam associated with a second beam index over a duration.

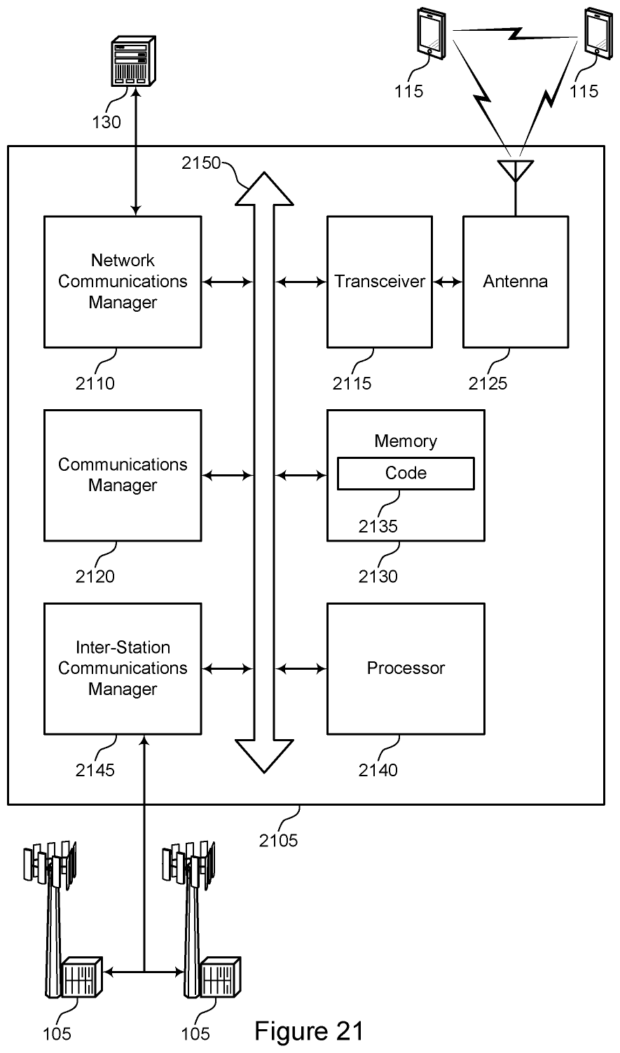

FIG. 21 shows a diagram of a system including a device 2105 that supports signaling enhancement for beam change predictions via modeling in accordance with aspects of the present disclosure. The device 2105 may be an example of or include the components of a device 1805, a device 1905, or a base station 105 as described in the present disclosure. The device 2105 may communicate wirelessly with one or more base stations 105, UEs 115, or any combination thereof. The device 2105 may include components for bi-directional voice and data communications including components for transmitting and receiving communications, such as a communications manager 2120, a network communications manager 2110, a transceiver 2115, an antenna 2125, a memory 2130, code 2135, a processor 2140, and an inter-station communications manager 2145. These components may be in electronic communication or otherwise coupled (for example, operatively, communicatively, functionally, electronically, electrically) via one or more buses (for example, a bus 2150).

The network communications manager 2110 may manage communications with a core network 130 (for example, via one or more wired backhaul links). For example, the network communications manager 2110 may manage the transfer of data communications for client devices, such as one or more UEs 115.

In some examples, the device 2105 may include a single antenna 2125. However, in some other cases the device 2105 may have more than one antenna 2125, which may be capable of concurrently transmitting or receiving multiple wireless transmissions. The transceiver 2115 may communicate bi-directionally, via the one or more antennas 2125, wired, or wireless links as described in the present disclosure. For example, the transceiver 2115 may represent a wireless transceiver and may communicate bi-directionally with another wireless transceiver. The transceiver 2115 may also include a modem to modulate the packets, to provide the modulated packets to one or more antennas 2125 for transmission, and to demodulate packets received from the one or more antennas 2125. The transceiver 2115, or the transceiver 2115 and one or more antennas 2125, may be an example of a transmitter 1815, a transmitter 1915, a receiver 1810, a receiver 1910, or any combination thereof or component thereof, as described in the present disclosure.

The memory 2130 may include RAM and ROM. The memory 2130 may store computer-readable, computer-executable code 2135 including instructions that, in examples in which the instructions are executed by the processor 2140, cause the device 2105 to perform various functions described in the present disclosure. The code 2135 may be stored in a non-transitory computer-readable medium such as system memory or another type of memory. In some examples, the code 2135 may not be directly executable by the processor 2140 but may cause a computer (for example, in which the code is compiled and executed) to perform functions described in the present disclosure. In some examples, the memory 2130 may contain, among other things, a BIOS which may control basic hardware or software operation such as the interaction with peripheral components or devices.

The processor 2140 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some examples, the processor 2140 may be configured to operate a memory array using a memory controller. In some other cases, a memory controller may be integrated into the processor 2140. The processor 2140 may be configured to execute computer-readable instructions stored in a memory (for example, the memory 2130) to cause the device 2105 to perform various functions (for example, functions or tasks supporting signaling enhancement for beam change predictions via modeling). For example, the device 2105 or a component of the device 2105 may include a processor 2140 and memory 2130 coupled with the processor 2140, the processor 2140 and memory 2130 configured to perform various functions described in the present disclosure.

The inter-station communications manager 2145 may manage communications with other base stations 105, and may include a controller or scheduler for controlling communications with UEs 115 in cooperation with other base stations 105. For example, the inter-station communications manager 2145 may coordinate scheduling for transmissions to UEs 115 for various interference mitigation techniques such as beamforming or joint transmission. In some examples, the inter-station communications manager 2145 may provide an X2 interface within an LTE/LTE-A wireless communications network technology to provide communication between base stations 105.

The communications manager 2120 may support wireless communication at a base station (for example, the device 2105) in accordance with examples as disclosed in the present disclosure. For example, the communications manager 2120 may be configured as or otherwise support a means for transmitting, to a UE, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams. The communications manager 2120 may be configured as or otherwise support a means for transmitting, to the UE, a reference signal associated with a beam of the set of beams. The communications manager 2120 may be configured as or otherwise support a means for receiving, from the UE, a status indication associated with whether an adjustment of the beam will occur, the status indication based on the HMM configuration and the reference signal.

By including or configuring the communications manager 2120 in accordance with examples as described in the present disclosure, the device 2105 may support techniques for beam change predictions via an HMM at a UE 115, which may result in communication reliability, reduced power consumption, more efficient utilization of communication resources, and longer battery life.

In some examples, the communications manager 2120 may be configured to perform various operations (for example, receiving, monitoring, transmitting) using or otherwise in cooperation with the transceiver 2115, the one or more antennas 2125, or any combination thereof. Although the communications manager 2120 is illustrated as a separate component, in some examples, one or more functions described with reference to the communications manager 2120 may be supported by or performed by the processor 2140, the memory 2130, the code 2135, or any combination thereof. For example, the code 2135 may include instructions executable by the processor 2140 to cause the device 2105 to perform various aspects of signaling enhancement for beam change predictions via modeling as described in the present disclosure, or the processor 2140 and the memory 2130 may be otherwise configured to perform or support such operations.

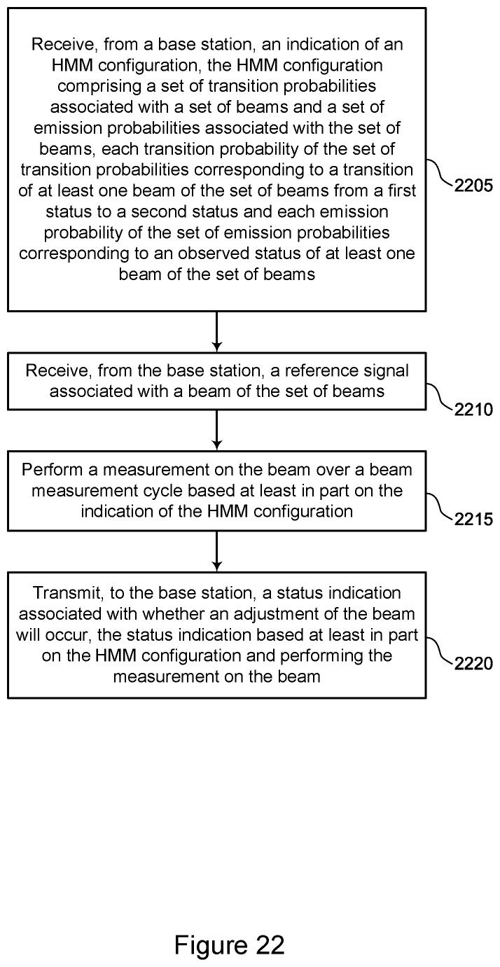

FIG. 22 shows a flowchart illustrating a method that supports signaling enhancement for beam change predictions via modeling in accordance with aspects of the present disclosure. The operations of the method may be implemented by a UE or its components as described in the present disclosure. For example, the operations of the method may be performed by a UE 115 as described with reference to FIGS. 1-25. In some examples, a UE may execute a set of instructions to control the functional elements of the UE to perform the described functions. Additionally or alternatively, the UE may perform aspects of the described functions using special-purpose hardware.

At 2205, the method may include receiving, from a base station, an indication of an HMM configuration, the HMM including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams. The operations of 2205 may be performed in accordance with examples as disclosed in the present disclosure. In some examples, aspects of the operations of 2205 may be performed by an HMM configuration component 1625 as described with reference to FIG. 16.

At 2210, the method may include receiving, from the base station, a reference signal associated with a beam of the set of beams. The operations of 2210 may be performed in accordance with examples as disclosed in the present disclosure. In some examples, aspects of the operations of 2210 may be performed by a reference signal component 1630 as described with reference to FIG. 16.

At 2215, the method may include performing a measurement on the beam over a beam measurement cycle based on the indication of the HMM configuration. The operations of 2215 may be performed in accordance with examples as disclosed in the present disclosure. In some examples, aspects of the operations of 2215 may be performed by a beam measurement component 1635 as described with reference to FIG. 16.

At 2220, the method may include transmitting, to the base station, a status indication associated with whether an adjustment of the beam will occur, the status indication based on the HMM configuration and performing the measurement on the beam. The operations of 2220 may be performed in accordance with examples as disclosed in the present disclosure. In some examples, aspects of the operations of 2220 may be performed by a status indication component 1640 as described with reference to FIG. 16.

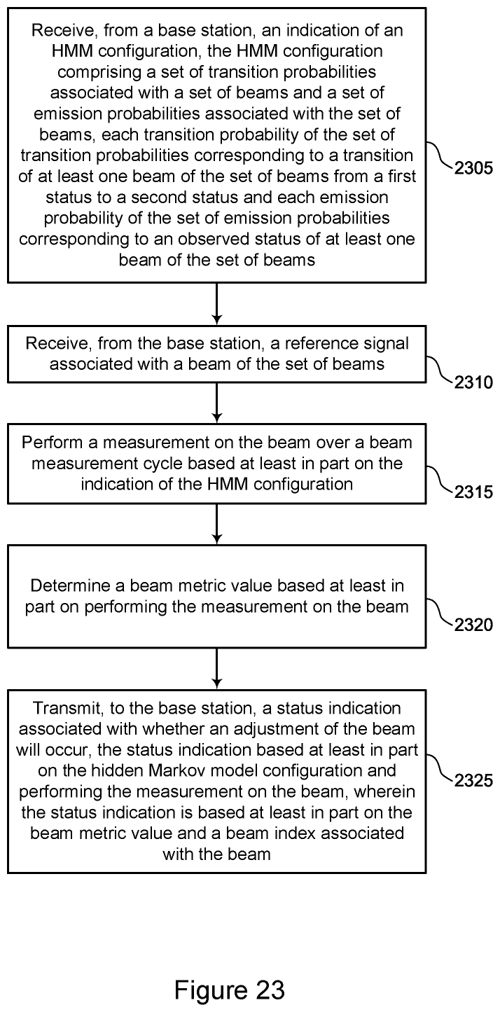

FIG. 23 shows a flowchart illustrating a method that supports signaling enhancement for beam change predictions via modeling in accordance with aspects of the present disclosure. The operations of the method may be implemented by a UE or its components as described in the present disclosure. For example, the operations of the method may be performed by a UE 115 as described with reference to FIGS. 1-25. In some examples, a UE may execute a set of instructions to control the functional elements of the UE to perform the described functions. Additionally or alternatively, the UE may perform aspects of the described functions using special-purpose hardware.

At 2305, the method may include receiving, from a base station, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams. The operations of 2305 may be performed in accordance with examples as disclosed in the present disclosure. In some examples, aspects of the operations of 2305 may be performed by an HMM configuration component 1625 as described with reference to FIG. 16.

At 2310, the method may include receiving, from the base station, a reference signal associated with a beam of the set of beams. The operations of 2310 may be performed in accordance with examples as disclosed in the present disclosure. In some examples, aspects of the operations of 2310 may be performed by a reference signal component 1630 as described with reference to FIG. 16.

At 2315, the method may include performing a measurement on the beam over a beam measurement cycle based on the indication of the HMM configuration. The operations of 2315 may be performed in accordance with examples as disclosed in the present disclosure. In some examples, aspects of the operations of 2315 may be performed by a beam measurement component 1635 as described with reference to FIG. 16.

At 2320, the method may include determining a beam metric value based on performing the measurement on the beam. The operations of 2320 may be performed in accordance with examples as disclosed in the present disclosure. In some examples, aspects of the operations of 2320 may be performed by a beam measurement component 1635 as described with reference to FIG. 16.

At 2325, the method may include transmitting, to the base station, a status indication associated with whether an adjustment of the beam will occur, the status indication based on the HMM configuration and performing the measurement on the beam. In some examples, the status indication is based on the beam metric value and a beam index associated with the beam. The operations of 2325 may be performed in accordance with examples as disclosed in the present disclosure. In some examples, aspects of the operations of 2325 may be performed by a status indication component 1640 as described with reference to FIG. 16.

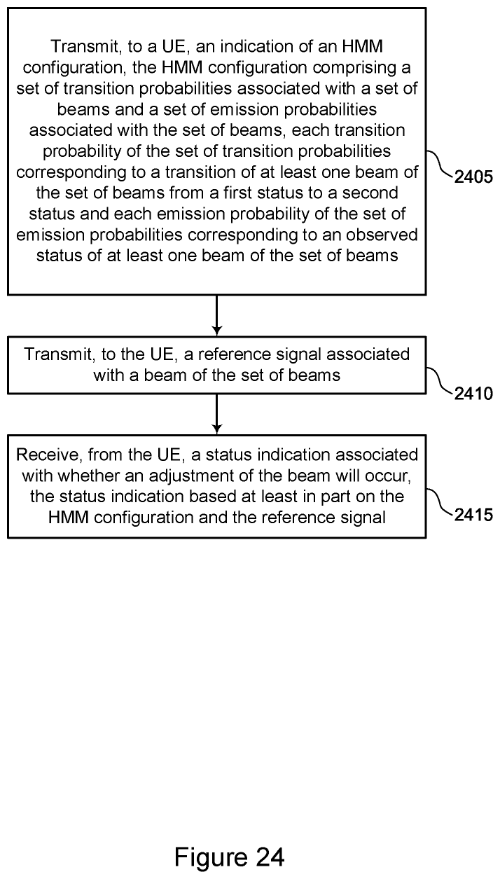

FIG. 24 shows a flowchart illustrating a method that supports signaling enhancement for beam change predictions via modeling in accordance with aspects of the present disclosure. The operations of the method may be implemented by a base station or its components as described in the present disclosure. For example, the operations of the method may be performed by a base station 105 as described with reference to FIGS. 1-7 and 22-25. In some examples, a base station may execute a set of instructions to control the functional elements of the base station to perform the described functions. Additionally or alternatively, the base station may perform aspects of the described functions using special-purpose hardware.

At 2405, the method may include transmitting, to a UE, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams. The operations of 2405 may be performed in accordance with examples as disclosed in the present disclosure. In some examples, aspects of the operations of 2405 may be performed by an HMM indication component 2025 as described with reference to FIG. 20.

At 2410, the method may include transmitting, to the UE, a reference signal associated with a beam of the set of beams. The operations of 2410 may be performed in accordance with examples as disclosed in the present disclosure. In some examples, aspects of the operations of 2410 may be performed by a reference signal transmitting component 2030 as described with reference to FIG. 20.

At 2415, the method may include receiving, from the UE, a status indication associated with whether an adjustment of the beam will occur, the status indication based on the HMM configuration and the reference signal. The operations of 2415 may be performed in accordance with examples as disclosed in the present disclosure. In some examples, aspects of the operations of 2415 may be performed by a beam adjustment component 2035 as described with reference to FIG. 20.

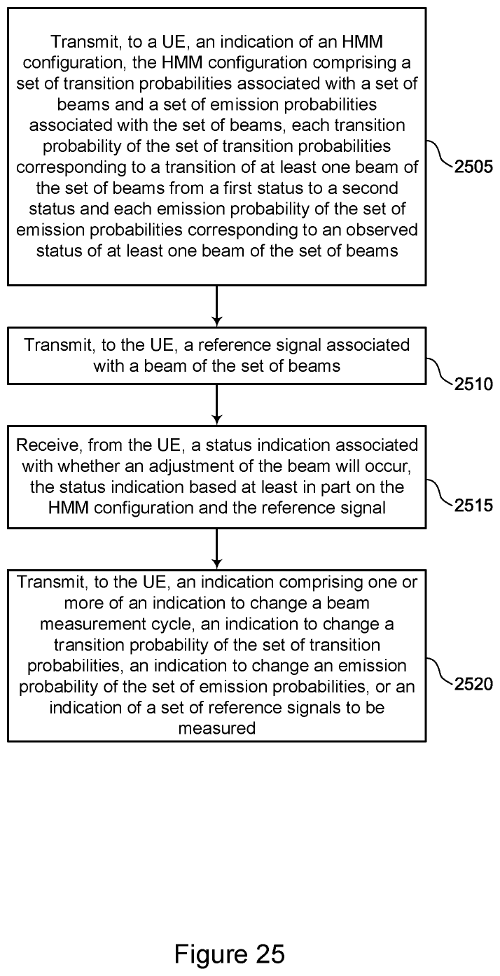

FIG. 25 shows a flowchart illustrating a method that supports signaling enhancement for beam change predictions via modeling in accordance with aspects of the present disclosure. The operations of the method may be implemented by a base station or its components as described in the present disclosure. For example, the operations of the method may be performed by a base station 105 as described with reference to FIGS. 1-7 and 22-25. In some examples, a base station may execute a set of instructions to control the functional elements of the base station to perform the described functions. Additionally or alternatively, the base station may perform aspects of the described functions using special-purpose hardware.

At 2505, the method may include transmitting, to a UE, an indication of an HMM configuration, the HMM configuration including a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams. The operations of 2505 may be performed in accordance with examples as disclosed in the present disclosure. In some examples, aspects of the operations of 2505 may be performed by an HMM indication component 2025 as described with reference to FIG. 20.

At 2510, the method may include transmitting, to the UE, a reference signal associated with a beam of the set of beams. The operations of 2510 may be performed in accordance with examples as disclosed in the present disclosure. In some examples, aspects of the operations of 2510 may be performed by a reference signal transmitting component 2030 as described with reference to FIG. 20.

At 2515, the method may include receiving, from the UE, a status indication associated with whether an adjustment of the beam will occur, the status indication based on the HMM configuration and the reference signal. The operations of 2515 may be performed in accordance with examples as disclosed in the present disclosure. In some examples, aspects of the operations of 2515 may be performed by a beam adjustment component 2035 as described with reference to FIG. 20.

At 2520, the method may include transmitting, to the UE, an indication including one or more of an indication to change a beam measurement cycle, an indication to change a transition probability of the set of transition probabilities, an indication to change an emission probability of the set of emission probabilities, or an indication of a set of reference signals to be measured. The operations of 2520 may be performed in accordance with examples as disclosed in the present disclosure. In some examples, aspects of the operations of 2520 may be performed by an indication transmitting component 2040 as described with reference to FIG. 20.

The following provides an overview of aspects of the present disclosure:

Aspect 1: A method for wireless communication at a UE, comprising: receiving, from a network node, a reference signal associated with a beam of a set of beams used for wireless communications at the UE, each beam of the set of beams being associated with a respective beam index; determining a probability associated with an adjustment of the beam, the probability indicating whether the beam will change over a duration from a first beam associated with a first beam index to a second beam associated with a second beam index based at least in part on the reference signal; and transmitting, to the network node, an indication of the probability associated with the adjustment of the beam.

Aspect 2: The method of aspect 1, wherein transmitting an indication of the probability comprises: transmitting, to the network node, a status indication associated with whether the adjustment of the beam will occur, wherein transmitting the status indication is based at least in part on the probability.

Aspect 3: The method of aspect 2, further comprising: receiving, from the network node, an indication of a threshold; and determining whether the probability satisfies the threshold, wherein transmitting the status indication is based at least in part on the probability satisfying the threshold.

Aspect 4: The method of any of aspects 2 through 3, further comprising: transmitting, to the network node, an indication of a threshold; and determining whether the probability satisfies the threshold, wherein transmitting the status indication is based at least in part on the probability satisfying the threshold.

Aspect 5: The method of any of aspects 2 through 4, further comprising: determining whether the probability satisfies a threshold, wherein transmitting the status indication comprises: transmitting, to the network node, a report comprising the status indication and an indication of the threshold.

Aspect 6: The method of any of aspects 2 through 5, further comprising: receiving, from the network node, an indication of a set of thresholds; selecting a threshold of the set of thresholds based at least in part on a performance metric associated with performing a measurement on the beam; and determining whether the probability satisfies the threshold, wherein transmitting the status indication is based at least in part on the probability satisfying the threshold.

Aspect 7: The method of any of aspects 1 through 6, further comprising transmitting, to the network node, an indication of a capability of the UE to determine the probability associated with the adjustment of the beam.

Aspect 8: The method of any of aspects 1 through 7, wherein determining the probability is based at least in part on a machine learning model.

Aspect 9: The method of aspect 8, wherein the machine learning model comprises one or more of a long short-term memory neural network, a gated recurrent unit neural network, a convolution neural network, a recurrent neural network, or a deep neural network.

Aspect 10: The method of aspect 9, further comprising receiving, from the network node, an indication of the machine learning model, wherein determining the probability is based at least in part on receiving the indication.

Aspect 11: The method of any of aspects 9 through 10, further comprising determining the machine learning model at the UE, wherein determining the probability is based at least in part on determining the machine learning model.

Aspect 12: The method of aspect 8, wherein the machine learning model comprises a hidden Markov Model.

Aspect 13: The method of aspect 12, further comprising receiving, from the network node, an indication of a hidden Markov model configuration, the hidden Markov model configuration comprising a set of transition probabilities associated with the set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams, wherein determining the probability is based at least in part on receiving the indication of the hidden Markov model configuration.

Aspect 14: The method of any of aspects 1 through 13, wherein transmitting the indication of the probability comprises transmitting, to the network node, a report comprising the indication of the probability.

Aspect 15: The method of aspect 14, wherein transmitting the report comprising the indication of the probability comprises: transmit a first channel state information report that indicates one or more measured channel characteristics of a channel used for the wireless communications between the UE and the network node; and transmit a second channel state information report that indicates the probability.

Aspect 16: The method of any of aspects 1 through 15, further comprising: performing a measurement on the beam over a beam measurement cycle; and determining a beam metric value based at least in part on performing the measurement on the beam, wherein the probability is based at least in part on the beam metric value and a beam index associated with the beam.

Aspect 17: The method of aspect 16, wherein the beam index associated with the beam comprises the first beam index or the second beam index.

Aspect 18: The method of any of aspects 16 through 17, further comprising determining one or both of whether the beam metric value changed relative to a second beam metric value associated with a second beam measurement cycle or whether the beam index changed relative to the second beam index associated with the second beam measurement cycle, wherein transmitting the indication of the probability is based at least in part on determining one or both of whether the beam metric value changed relative to the second beam metric value associated with the second beam measurement cycle or whether the beam index changed relative to the second beam index associated with the second beam measurement cycle.

Aspect 19: The method of any of aspects 16 through 18, further comprising receiving, from the network node, an indication comprising one or both of an indication to change the beam measurement cycle or an indication of a set of reference signals to be measured.

Aspect 20: The method of aspect 19, wherein the indication is received via an RRC message, a downlink control information, or a MAC-CE.

Aspect 21: The method of any of aspects 19 through 20, wherein the indication is based at least in part on one or both of a position of the UE or a trajectory of the UE.

Aspect 22: The method of any of aspects 1 through 21, further comprising transmitting, to the network node, a request based at least in part on the probability, the request comprising one or more of a request to decrease a report periodicity, a request to trigger one or more reports, a request to change a number of resources associated with a report, a predicted change in the beam, or a predicted change of the beam from the first beam to the second beam different from the beam.

Aspect 23: The method of any of aspects 1 through 22, wherein the beam of the set of beams used for the wireless communications at the UE is a top beam.

Aspect 24: An apparatus for wireless communication at a UE, comprising a processor; memory coupled with the processor; and instructions stored in the memory and executable by the processor to cause the apparatus to perform a method of any of aspects 1 through 22.

Aspect 25: An apparatus for wireless communication at a UE, comprising at least one means for performing a method of any of aspects 1 through 23.

Aspect 26: A non-transitory computer-readable medium storing code for wireless communication at a UE, the code comprising instructions executable by a processor to perform a method of any of aspects 1 through 23.

Aspect 27: A method for wireless communication at a UE, comprising: receiving, from a base station, an indication of an HMM configuration, the HMM configuration comprising a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams; receiving, from the base station, a reference signal associated with a beam of the set of beams; performing a measurement on the beam over a beam measurement cycle based at least in part on the indication of the HMM configuration; and transmitting, to the base station, a status indication associated with whether an adjustment of the beam will occur, the status indication based at least in part on the HMM configuration and performing the measurement on the beam.

Aspect 28: The method of aspect 27, wherein the set of transition probabilities and the set of emission probabilities of the HMM configuration are associated with whether a beam metric changed from a second beam measurement cycle to the beam measurement cycle, the beam metric based at least in part on performing the measurement on the beam.

Aspect 29: The method of any of aspects 27 through 28, further comprising: determining a beam metric value based at least in part on performing the measurement on the beam, wherein the status indication is based at least in part on the beam metric value and a beam index associated with the beam.

Aspect 30: The method of aspect 29, further comprising: determining one or both of whether the beam metric value changed relative to a second beam metric value associated with a second beam measurement cycle or whether the beam index changed relative to a second beam index associated with the second beam measurement cycle, wherein transmitting the status indication is based at least in part on the determination.

Aspect 31: The method of any of aspects 27 through 20, further comprising: receiving, from the base station, an indication comprising one or more of an indication to change the beam measurement cycle, an indication to change a transition probability of the set of transition probabilities, an indication to change an emission probability of the set of emission probabilities, or an indication of a set of reference signals to be measured.

Aspect 32: The method of aspect 31, wherein the indication is received via an RRC message, a DCI, or a MAC-CE.

Aspect 33: The method of any of aspects 31 through 32, wherein the indication is based at least in part on one or both of a position of the UE or a trajectory of the UE.

Aspect 34: The method of any of aspects 27 through 33, further comprising: transmitting, to the base station, a request based at least in part on the status indication, the request comprising one or more of a request to decrease a report periodicity, a request to trigger one or more reports, a request to change a number of resources associated with a report, a predicted change in the beam, or a predicted change from the beam to a second beam different from the beam.

Aspect 35: The method of any of aspects 27 through 34, further comprising: determining, based at least in part on the HMM configuration and performing the measurement on the beam, a probability associated with the adjustment of the beam, wherein transmitting the status indication is based at least in part on the probability.

Aspect 36: The method of aspect 35, further comprising: receiving, from the base station, an indication of a threshold; determining whether the probability satisfies the threshold, wherein transmitting the status indication is based at least in part on the probability satisfying the threshold.

Aspect 37: The method of aspect 35, further comprising: transmitting, to the base station, an indication of a threshold, wherein receiving the HMM configuration is based at least in part on transmitting the indication of the threshold; and determining whether the probability satisfies the threshold, wherein transmitting the status indication is based at least in part on the probability satisfying the threshold.

Aspect 38: The method of aspect 35, further comprising: determining whether the probability satisfies a threshold, wherein transmitting the status indication comprises: transmitting, to the base station, a report comprising the status indication and an indication of the threshold.

Aspect 39: The method of aspect 35, further comprising: receiving, from the base station, an indication of a set of thresholds; selecting a threshold of the set of thresholds based at least in part on a performance metric associated with performing the measurement; determining whether the probability satisfies the selected threshold, wherein transmitting the status indication is based at least in part on the selected probability satisfying the threshold.

Aspect 40: The method of any of aspects 27 through 39, further comprising: transmitting, to the base station, an indication of a capability of the UE to determine a probability associated with the adjustment of the beam based at least in part on an HMM corresponding to the HMM configuration.

Aspect 41: The method of any of aspects 27 through 40, wherein the status indication indicates whether the beam will change from a first beam associated with a first beam index to a second beam associated with a second beam index over a duration.

Aspect 42: A method for wireless communication at a base station, comprising: transmitting, to a UE, an indication of an HMM configuration, the HMM configuration comprising a set of transition probabilities associated with a set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams; transmitting, to the UE, a reference signal associated with a beam of the set of beams; and receiving, from the UE, a status indication associated with whether an adjustment of the beam will occur, the status indication based at least in part on the HMM configuration and the reference signal.

Aspect 43: The method of aspect 42, wherein the set of transition probabilities and the set of emission probabilities of the HMM configuration are associated with whether a beam metric changed from a second beam measurement cycle to a beam measurement cycle, the beam metric corresponding to a measurement of the beam.

Aspect 44: The method of any of aspects 42 through 43, further comprising: transmitting, to the UE, an indication comprising one or more of an indication to change a beam measurement cycle, an indication to change a transition probability of the set of transition probabilities, an indication to change an emission probability of the set of emission probabilities, or an indication of a set of reference signals to be measured.

Aspect 45: The method of aspect 44, wherein the indication is transmitted via an RRC message, a DCI, or a MAC-CE.

Aspect 46: The method of any of aspects 44 through 45, further comprising: determining one or both of a position of the UE or a trajectory of the UE, wherein the indication is based at least in part on one or both of the position of the UE or the trajectory of the UE.

Aspect 47: The method of any of aspects 42 through 46, further comprising: receiving, from the UE, a request based at least in part on the status indication, the request comprising one or more of a request to decrease a report periodicity, a request to trigger one or more reports, a request to change a number of resources associated with a report, a predicted change in the beam, or a predicted change from the beam to a second beam different from the beam.

Aspect 48: The method of any of aspects 42 through 47, further comprising: transmitting, to the UE, an indication of a threshold, wherein the status indication is based at least in part on a probability associated with the adjustment of the beam satisfying the threshold.

Aspect 49: The method of any of aspects 42 through 47, further comprising: receiving, from the UE, an indication of a threshold, wherein transmitting the HMM configuration is based at least in part on receiving the indication of the threshold.

Aspect 50: The method of any of aspects 42 through 47, further comprising: receiving, from the UE, a report comprising the status indication and an indication of a threshold, wherein the status indication is based at least in part on a probability associated with the adjustment of the beam satisfying the threshold.

Aspect 51: The method of any of aspects 42 through 47, further comprising: receiving, from the UE, an indication of a capability of the UE to determine a probability associated with the adjustment of the beam based at least in part on an HMM corresponding to the HMM configuration.

Aspect 52: The method of any of aspects 42 through 47, wherein the status indication indicates whether the beam will change from a first beam associated with a first beam index to a second beam associated with a second beam index over a duration.

Aspect 53: An apparatus for wireless communication at a UE, comprising a processor; memory coupled with the processor; and instructions stored in the memory and executable by the processor to cause the apparatus to perform a method of any of aspects 27 through 41.

Aspect 54: An apparatus for wireless communication at a UE, comprising at least one means for performing a method of any of aspects 27 through 41.

Aspect 55: A non-transitory computer-readable medium storing code for wireless communication at a UE, the code comprising instructions executable by a processor to perform a method of any of aspects 27 through 41.

Aspect 56: An apparatus for wireless communication at a base station, comprising a processor; memory coupled with the processor; and instructions stored in the memory and executable by the processor to cause the apparatus to perform a method of any of aspects 42 through 47.

Aspect 57: An apparatus for wireless communication at a base station, comprising at least one means for performing a method of any of aspects 42 through 47.

Aspect 58: A non-transitory computer-readable medium storing code for wireless communication at a base station, the code comprising instructions executable by a processor to perform a method of any of aspects 42 through 47.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a user equipment (UE), comprising:
receiving, from a network node, a reference signal associated with a beam of a set of beams used for wireless communications at the UE, each beam of the set of beams being associated with a respective beam index;
determining a probability associated with an adjustment of the beam, the probability indicating whether the beam will change over a duration from a first beam associated with a first beam index to a second beam associated with a second beam index based at least in part on the reference signal; and
transmitting, to the network node, an indication of the probability associated with the adjustment of the beam.

2. The method of claim 1, wherein transmitting an indication of the probability comprises:
transmitting, to the network node, a status indication associated with whether the adjustment of the beam will occur, wherein transmitting the status indication is based at least in part on the probability.

3. The method of claim 2, further comprising:
receiving, from the network node, an indication of a threshold; and
determining whether the probability satisfies the threshold, wherein transmitting the status indication is based at least in part on the probability satisfying the threshold.

4. The method of claim 2, further comprising:
transmitting, to the network node, an indication of a threshold; and
determining whether the probability satisfies the threshold, wherein transmitting the status indication is based at least in part on the probability satisfying the threshold.

5. The method of claim 2, further comprising:
determining whether the probability satisfies a threshold, wherein transmitting the status indication comprises:
transmitting, to the network node, a report comprising the status indication and an indication of the threshold.

6. The method of claim 2, further comprising:
receiving, from the network node, an indication of a set of thresholds;
selecting a threshold of the set of thresholds based at least in part on a performance metric associated with performing a measurement on the beam; and
determining whether the probability satisfies the threshold, wherein transmitting the status indication is based at least in part on the probability satisfying the threshold.

7. The method of claim 1, further comprising transmitting, to the network node, an indication of a capability of the UE to determine the probability associated with the adjustment of the beam.

8. The method of claim 1, wherein determining the probability is based at least in part on a machine learning model.

9. The method of claim 8, wherein the machine learning model comprises one or more of a long short-term memory neural network, a gated recurrent unit neural network, a convolution neural network, a recurrent neural network, or a deep neural network.

10. The method of claim 9, further comprising receiving, from the network node, an indication of the machine learning model, wherein determining the probability is based at least in part on receiving the indication.

11. The method of claim 9, further comprising determining the machine learning model at the UE, wherein determining the probability is based at least in part on determining the machine learning model.

12. The method of claim 8, wherein the machine learning model comprises a hidden Markov Model.

13. The method of claim 12, further comprising receiving, from the network node, an indication of a hidden Markov model configuration, the hidden Markov model configuration comprising a set of transition probabilities associated with the set of beams and a set of emission probabilities associated with the set of beams, each transition probability of the set of transition probabilities corresponding to a transition of at least one beam of the set of beams from a first status to a second status and each emission probability of the set of emission probabilities corresponding to an observed status of at least one beam of the set of beams, wherein determining the probability is based at least in part on receiving the indication of the hidden Markov model configuration.

14. The method of claim 1, wherein transmitting the indication of the probability comprises transmitting, to the network node, a report comprising the indication of the probability.

15. The method of claim 14, wherein transmitting the report comprising the indication of the probability comprises:
transmit a first channel state information report that indicates one or more measured channel characteristics of a channel used for the wireless communications between the UE and the network node; and
transmit a second channel state information report that indicates the probability.

16. The method of claim 1, further comprising:
performing a measurement on the beam over a beam measurement cycle; and
determining a beam metric value based at least in part on performing the measurement on the beam, wherein the probability is based at least in part on the beam metric value and a beam index associated with the beam.

17. The method of claim 16, wherein the beam index associated with the beam comprises the first beam index or the second beam index.

18. The method of claim 16, further comprising determining one or both of whether the beam metric value changed relative to a second beam metric value associated with a second beam measurement cycle or whether the beam index changed relative to the second beam index associated with the second beam measurement cycle, wherein transmitting the indication of the probability is based at least in part on determining one or both of whether the beam metric value changed relative to the second beam metric value associated with the second beam measurement cycle or whether the beam index changed relative to the second beam index associated with the second beam measurement cycle.

19. The method of claim 16, further comprising receiving, from the network node, an indication comprising one or both of an indication to change the beam measurement cycle or an indication of a set of reference signals to be measured.

20. The method of claim 19, wherein the indication is received via a radio resource control message, a downlink control information, or a medium access control control element.

21. method of claim 19, wherein the indication is based at least in part on one or both of a position of the UE or a trajectory of the UE.

22. method of claim 1, further comprising transmitting, to the network node, a request based at least in part on the probability, the request comprising one or more of a request to decrease a report periodicity, a request to trigger one or more reports, a request to change a number of resources associated with a report, a predicted change in the beam, or a predicted change of the beam from the first beam to the second beam different from the beam.

23. The method of claim 1, wherein the beam of the set of beams used for the wireless communications at the UE is a top beam.

24. An apparatus for wireless communication at a user equipment (UE), comprising:
a processor; and
memory coupled with the processor and storing instructions executable by the processor to cause the apparatus to:
receive, from a network node, a reference signal associated with a beam of a set of beams used for wireless communications at the UE, each beam of the set of beams being associated with a respective beam index;
determine a probability associated with an adjustment of the beam, the probability indicating whether the beam will change over a duration from a first beam associated with a first beam index to a second beam associated with a second beam index based at least in part on the reference signal; and
transmit, to the network node, an indication of the probability associated with the adjustment of the beam.

25. The apparatus of claim 24, wherein the instructions to transmit an indication of the probability are executable by the processor to cause the apparatus to:
transmit, to the network node, a status indication associated with whether the adjustment of the beam will occur, wherein transmitting the status indication is based at least in part on the probability.

26. The apparatus of claim 25, wherein the instructions are further executable by the processor to cause the apparatus to:
receive, from the network node, an indication of a threshold; and
determine whether the probability satisfies the threshold, wherein transmitting the status indication is based at least in part on the probability satisfying the threshold.

27. The apparatus of claim 25, wherein the instructions are further executable by the processor to cause the apparatus to:
transmit, to the network node, an indication of a threshold; and
determine whether the probability satisfies the threshold, wherein transmitting the status indication is based at least in part on the probability satisfying the threshold.

28. The apparatus of claim 25, wherein the instructions are further executable by the processor to cause the apparatus to:
determine whether the probability satisfies a threshold, wherein transmitting the status indication comprises:
transmit, to the network node, a report comprising the status indication and an indication of the threshold.

29-61. (canceled)

62. The apparatus of claim 25, wherein the instructions are further executable by the processor to cause the apparatus to:
receive, from the network node, an indication of a set of thresholds;
select a threshold of the set of thresholds based at least in part on a performance metric associated with performing a measurement on the beam; and
determine whether the probability satisfies the threshold, wherein transmitting the status indication is based at least in part on the probability satisfying the threshold.

63. A user equipment (UE) for wireless communications, comprising:
means for receiving, from a network node, a reference signal associated with a beam of a set of beams used for wireless communications at the UE, each beam of the set of beams being associated with a respective beam index;
means for determining a probability associated with an adjustment of the beam, the probability indicating whether the beam will change over a duration from a first beam associated with a first beam index to a second beam associated with a second beam index based at least in part on the reference signal; and
means for transmitting, to the network node, an indication of the probability associated with the adjustment of the beam.
